(19) United States
(12) Patent Application Publication
(10) Pub. No.: US 2014/0379478 A1
(43) Pub. Date: Dec. 25, 2014

(54) SYSTEM AND METHOD FOR IMPLEMENTING AN INTERACTIVE MEDIA KIOSK NETWORK

(71) Applicant: James Terry Pulford, Encinitas, CA (US)

(72) Inventor: James Terry Pulford, Encinitas, CA (US)

(21) Appl. No.: 14/289,034

(22) Filed: May 28, 2014

Related U.S. Application Data
(63) Continuation of application No. 12/831,260, filed on Jul. 7, 2010, now abandoned.

(51) Int. Cl. G06Q 30/02; G06Q 20/18

(52) U.S. Cl. CPC G06Q 30/0261; G06Q 20/18
USPC 705/14.58

(57) ABSTRACT

An interactive media recording and broadcasting system includes an interactive digital media recording and broadcasting kiosk for interacting, recording and broadcasting media, a web server for storing and serving data, an advertising platform, and a social media network website.

### CROSS-REFERENCE TO RELATED APPLICATIONS

This application is a continuation of and claims a priority benefit to prior U.S. Non-Provisional patent application Ser. No. 12/831,260 filed on Jul. 7, 2010. The foregoing application is hereby expressly incorporated by reference in its entirety. Furthermore, any and all priority claims identified in the Application Data Sheet, or any correction thereto, are hereby incorporated by reference under 37 C.F.R. §1.57.

### REFERENCES CITED

| | | |
|---|---|---|
| 6,085,195 | July 2000 | Hoyt et al. |

A computer program product for an interactive public kiosk including a processor for automatically forming a web page including an image of a user, includes a computer readable media.

| | | |
|---|---|---|
| US 2003/0001846 A1 | January 2003 | Davis et al. |

An automatic personalized media creation system provides a capture area for a user where the invention elicits a performance from the user using audio and/or video cues and is automatically aptured.

| | | |
|---|---|---|
| 7,212,308 B2 | March 2007 | Morgan |

A digital image kiosk, comprising an imaging device adapted to electronically capture an image of an object, a display device adapted to display at least one of a captured image, a user interface adapted to display information to a user and to receive information from a user; a printing device adapted to print a manipulated or non-manipulated image on one or more sides of one or more substrates, a substrate handling device adapted to position a substrate in proximity to the printing device such that the printing device can print to the one or more substrates, a control unit in communication with the information suite, wherein the kiosk is adapted so that the printing device prints the image captured by the image capturing device on a first side of a set number of substrates having a preprinted and unique image on a second side of the set number of substrates.

| | | |
|---|---|---|
| US 2003/0038835 A1 | February 2003 | DeFelice |

An interactive digital imaging station and method for viewing and emailing electronic photos are disclosed.

| | | |
|---|---|---|
| US 2006/0170670 A1 | July 2006 | Burke |

The present invention provides an apparatus and methods for a photo-interactive consumer service and marketing system.

### FIELD OF THE INVENTION

The present invention relates to a network of interactive media recording kiosks utilizing hardware and proprietary software that allows communication between the kiosks, an integrated advertising platform and online applications.

### BACKGROUND OF THE INVENTION

Prior art in the form of earlier media recording kiosks such as photo booths have not had the ability to provide instant online social media and social networking per kiosk containing user-generated content, kiosk to kiosk communication, customizable interface, and a built-in advertising network. A user friendly and ubiquitously deployable network of media kiosks that capture, broadcast and transmit various types of content with other kiosks across the world, while instantaneously uploading, archiving and organizing content to the internet utilizing vehicles such as wireless technology for public viewing and the creation of an online community does not exist. In addition, a built-in advertising platform spans across the network and it's website creating an advertising system in which advertisers can hand select and pinpoint their ad reach to specific kiosk and website locations. Traditionally similar apparatuses have been enclosed within a booth, which tend to be obtrusive and provide an obstacle in regards the requirement of the space and square footage needed to house the apparatus. Prior art apparatuses are limited to a private experience, which generally consists of 1 to 2 people, and do not typically accommodate persons with physical disabilities. Other people cannot engage in the visual interaction with the kiosk due to the inherent enclosure. Each kiosk is paired with an online profile, content gallery, provides real time social networking, advertising opportunities, and remote content moderation, combined with the convenience of having an all-in-one audio and video recording device at your disposal. Prior art has only been able to send data where as this invention can send and receive data to and from kiosks and it's website network. The current invention provides a means for all the kiosks within a given network to virtually communicate with each other and the central website they are associated with. The ability to provide a medium of digitally created advertising on such an apparatus has not been utilized to date. Forms of previous attempts of communication such as advertising have been in a static print format that is applied to the housing of the apparatus rather than an on screen versatile format. Prior art has not combined the above-mentioned features along with external audio/video ports for projectors, televisions, and monitors for broadcasting. In addition the current invention has the ability to save and store data to a portable personal data device including but not limited to a cellular phone, USB device, or memory card. Prior art has not had remote/satellite/wireless data streaming capabilities to engage in a live kiosk to kiosk interaction and present content from a kiosk to a variety of audio/video devices. The kiosk network provides an advertising platform that is unique to this invention in that advertisers have the option to specifically target exactly where they want ads placed. Furthermore, proprietors of establishments housing/hosting the present invention, advertisers, or broadcasters subscribing content to the invention for example, have the opportunity to update, moderate, and manage content on the apparatus and it's online profile/gallery, something systems of prior art do not provide for. The kiosk network enables advertisers to target their market with ultimate precision due to the categories each kiosk can be assigned to. Prior art does not make use of categorized advertising opportunities or a web based interface to advertise directly on the kiosk(s) and online profiles/galleries of their choice.

### SUMMARY OF THE INVENTION

This invention overcomes the disadvantages of the prior art by connecting the media-recording kiosks to a live interactive network and proprietary advertising platform. Users will be able to instantaneously connect with others around the world during and after their interaction with the kiosk. Advertisements will be strategically placed/targeted. Each kiosk apparatus has the option of containing a computer or any type of microprocessor, CPU (Central Processing Unit), logic board or similar hardware, storage device, data ports, media inputs & outputs, a standard monitor or touch screen monitor, 3d, multiple monitors, camera, wired and wireless communication devices including but not limited to TCP/IP, wifi, Bluetooth, WiMAX, 3G CDMA, 4g, fiber optic and Local Area Network (LAN). Other components may include speakers, human interface device (HID), identification device (to read and interpret user identity), payment device, printer, media reader/writer, and lighting. Users will interact with the machine by viewing the media content displayed on the screen, listening to the content from the speakers enclosed in the kiosk and most importantly initiating it to record content in the form of pictures, video and/or audio posting comments, entering contact info, logging in. In low light conditions the current invention does not require an external light source for the purpose of capturing pictures or video. The kiosk embodiment will be unobtrusive and contain the options, but not limited to being mounted on a wall, resting on a table top or held up by a self-contained stand or suspension mount.

User(s) can interact with the kiosk (apparatus) that may display instructions along with other literature and graphics and begin the media recording session via a human interface device. Simultaneous user interaction is possible whereas prior art limits the number of users to the amount of space within the enclosure. In one embodiment a countdown may appear at the end of which the kiosk will start to record content in the form of pictures, video or audio for a specified period of time. The screen will then display that the recording time has elapsed, a confirmation message may be displayed along with a direct internet URL to their recorded media that they can instantly visit online. Upon completion of these steps, the kiosk will return back to the idle mode explained in the paragraph above until another user initiates a session with the kiosk. The kiosk has the ability for automated and or timed media capturing which could eliminate any user input. Another method in which users can add media to be displayed on kiosks is through the web interface. Each kiosk will have the ability to broadcast an up to date live slideshow/collage of the user-generated content, website members, along with displaying various content & media as specified by the kiosk moderator via the web interface. Users will have the capability to browse, interact, filter and search content at the kiosk.

When the kiosk is idle it will have the capability to display content that users have contributed such as still photos, audio or text comments, and videos from that specific location as well as any other kiosk within the network. The functionality to receive and format data from the Internet and other networks in the form of data, images, video, audio and text are a novel part of the current invention. This provides real time social networking opportunities that have not existed in the past. Kiosk administrators can update a calendar of events, add custom photos, news entries, and other content from the convenience of the kiosk network's web interface which will be synchronized between their online profile and their kiosk. Each kiosk will also communicate with a central network service including but not limited to a website where all content will instantaneously be available online for viewing, socializing and interacting, either from the kiosk or other network enabled devices. Whether you are at a location that has a kiosk or in front of a computer you will be able to see a live broadcast of user generated content as well as archived content. The content is searchable, sortable and filterable based on dates, number of views, votes, tags, categories, random selection, featured content, featured users, alphabetically, number of comments, geographic locations and other criteria.

Prior art does not contain a built-in advertising platform which enables advertisers the convenience to browse, select, and purchase advertising space on a per kiosk basis directly through the convenience of a web interface. The present invention will have the ability to display advertisements both on the kiosks (on screen, graphic print, ticket dispenser) and on the website in which advertisers can choose with per kiosk precision and purchase ad space through the web interface. The advertisements can be in the form of a physical medium such as print, or in the form of digital images, video, audio or text. Ads can be printed on the casing, tickets from dispenser, or any marketing/promotional items surrounding the kiosk such as rugs, coasters, pens, magnets, etc. Digital ads on the kiosk can rotate and/or integrate within the on-screen interface and/or embedded into the recorded media. Advertisers will also have the ability to display a graphic image on the front protective cover and the outer casing of the kiosk housing. Since each kiosk is paired with it's own unique profile/gallery on the networks central website, online advertisements can also be placed with demographic precision. Unlike prior art, advertisers can browse kiosks by location, demographics, popularity, and other pertinent data . . . then place ads on the associated website thus targeting their market with unmatched precision. The network's custom proprietary built-in advertising platform is another novel portion of this invention.

The content on any kiosk and it's associated website profile/gallery can be remotely managed and moderated by anyone with the proper authorization through the web interface. These individuals will also be able to add media through the web interface to be shown on the kiosk or their section on the website. This feature provides limitless capabilities to display content including but not limited to events, specials, announcements, promotions, and the like.

This kiosk will allow users to capture media content and have it automatically uploaded to a network service including but not limited to a website. It eliminates the need to carry a camera, video recorder or audio recorder. As explained above the kiosk provides real time social networking combined with the convenience of having an all-in-one audio and video recording device at your disposal. The current invention is a combination of networked media recording/broadcasting kiosks, proprietary advertising platform, real-time social media, an online community and place to virtually interact with physical locations. Prior art is limited to human to machine interaction where as the present invention enables human-to-human interaction through the kiosk network and website.

### BRIEF DESCRIPTION OF THE DRAWINGS

FIG. 1 is a front view illustrating the outside housing of the present invention.

FIG. 2 is a side view illustrating the outer casing of the present invention.

FIG. 3 is a front view illustrating the mounting & support panel along with the component brackets and fixtures of the kiosk with the cover removed.

FIG. 4 is a front view illustrating the components within the kiosk housing with the cover removed.

FIG. 5 is a schematic representation of the kiosk in idle mode in one embodiment.

FIG. 6 is a schematic representation of user interaction with the kiosk in one embodiment.

FIG. 7 is a schematic representation of automated actions that the kiosk performs in one embodiment.

FIG. 8 is a schematic representation of steps involved from recording media to it's delivery to a website and to a kiosk.

FIG. 9 is a schematic representation of the process of retrieving media and data from various sources and displaying them on the apparatus.

FIG. 10 is a schematic representation of browsing media on a kiosk utilizing a Human Interface Device.

FIG. 11 is a schematic representation of the various forms in which data and media are displayed.

FIG. 12 is a schematic representation of 2 kiosks interacting and communicating directly to one another.

FIG. 13 is a schematic representation of 2 kiosks interacting and communicating directly to on another via user selection.

FIG. 14 is a schematic representation of the user interaction with the central website that is linked to the network of kiosks.

FIG. 15 is a schematic representation of how users can interact with recorded media from a website.

FIG. 16 is a schematic representation of how users can interact with recorded media in further detail.

FIG. 17 is a schematic representation of how 2 users can meet through similar interest of a recorded media piece of content.

FIG. 18 is a schematic representation of how 2 users can meet through common interest of specific recorded media.

FIG. 19 is a schematic representation of how a kiosk location can be automatically recommended based on similar interests of another user.

FIG. 20 is a schematic representation of how media can be recommended based on similar interests of another user.

FIG. 21 is a schematic representation of how users can meet people within the network based on similar interests.

FIG. 22 is a schematic representation of how a user can meet people within the network on a personal level.

FIG. 23 is a schematic representation of a media popularity algorithm.

FIG. 24 is a schematic representation of a kiosk host location popularity algorithm.

FIG. 25 is a schematic representation of an kiosk administrator interacting with the central website that is linked to the network of kiosks.

FIG. 26 is a schematic representation of a kiosk administrator controlling the look and functionality of a kiosk interface.

FIG. 27 is a schematic representation of advertisers interacting with the central website that is linked to the network of kiosks.

FIG. 28 is a schematic representation of advertisers targeting specific kiosks and purchasing advertisements.

FIG. 29 is a schematic representation of advertisements displayed in print and digital form.

FIG. 30 is a schematic representation describing the various options in which advertisements can be displayed online.

FIG. 31 is a schematic representation describing how location based advertising on a kiosk can be leveraged for optimal placement of ads.

FIG. 32 is a schematic representation describing how category based advertising on a kiosk can be leveraged for optimal placement of ads.

FIG. 33 is an example recorded media digital file with advertisements directly embedded into it.

FIG. 34 is an example of a printed media file with advertisements directly embedded into it.

FIG. 35 shows how media can be displayed on the apparatus' screen in a montage format.

FIG. 36 shows what a user sees during the recording process.

FIG. 37 shows the graphical print advertising area on the apparatus.

FIG. 38 shows an example of recorded media with embedded advertisements as displayed on the website.

FIG. 39 shows how media can be displayed on the website in a montage format.

FIG. 40 shows how a media gallery with integrated advertisements can be shown online.

FIG. 41 shows advertising areas within a media gallery page on the website.

FIG. 42 shows a view on the website of a single piece of recorded media with advertising areas.

FIG. 43 is a schematic representation of grouping kiosks together utilizing categorization.

FIG. 44 is a schematic representation of how each kiosk is associated with a unique page and gallery on the website.

### DETAILED DESCRIPTION OF THE INVENTION

As used herein, “kiosk” refers to the media recording and broadcasting apparatus.

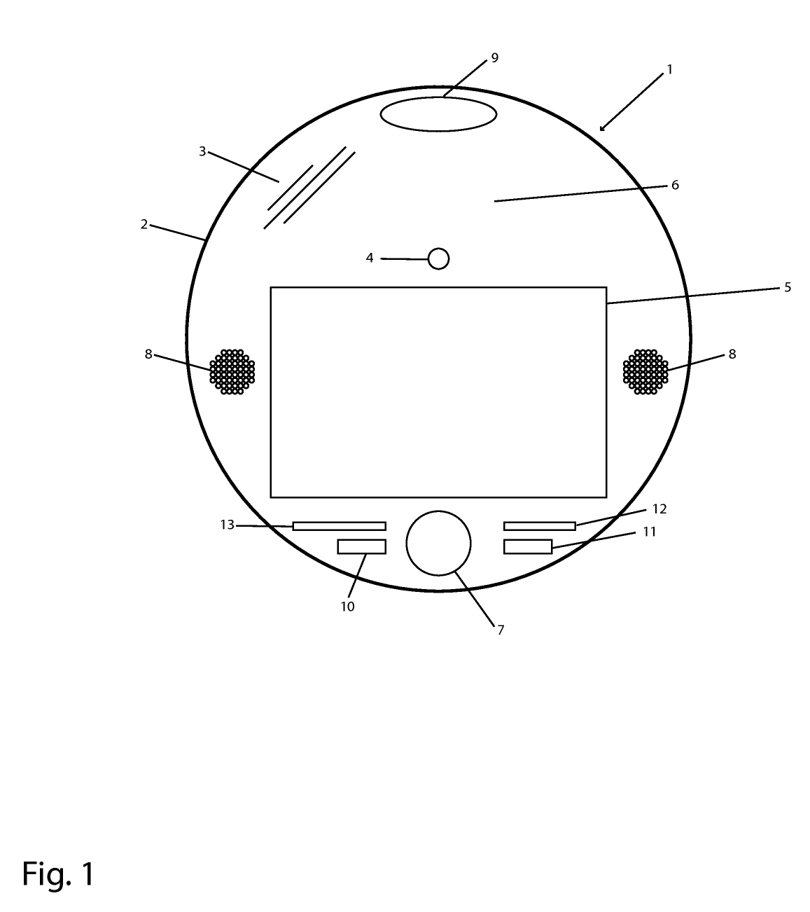

Referring now to FIG. 1 The kiosk in one potential embodiment has a sleek, unobtrusive design that may be mounted on a wall and is comprised of a housing 1 which contains an outer casing 2 that covers the side of the kiosk and will be attached to the front protective cover 3. The front protective cover contains an area available for a graphic print and/or advertising area 6. Contained within the kiosk housing is a camera and microphone 4 with the option for automatic focus and operate in low light situations to record pictures and video. The option for additional light will be available 9. The front protective cover 3 contains a human interface device 7 and when it has been triggered will begin the media recording process. The recorded content will be displayed on the touch screen capable monitor 5 and/or speakers 8. Wireless or wired audio/video output port 10 enables external audio/video devices to be attached. The kiosk can contain a portable digital storage device port 11 that allows users to load and save content, payment & identification device 12 to accept payments and identify users and printer 13 for printing content. Other possible embodiments may include the use of the touch screen interaction and/or voice activation.

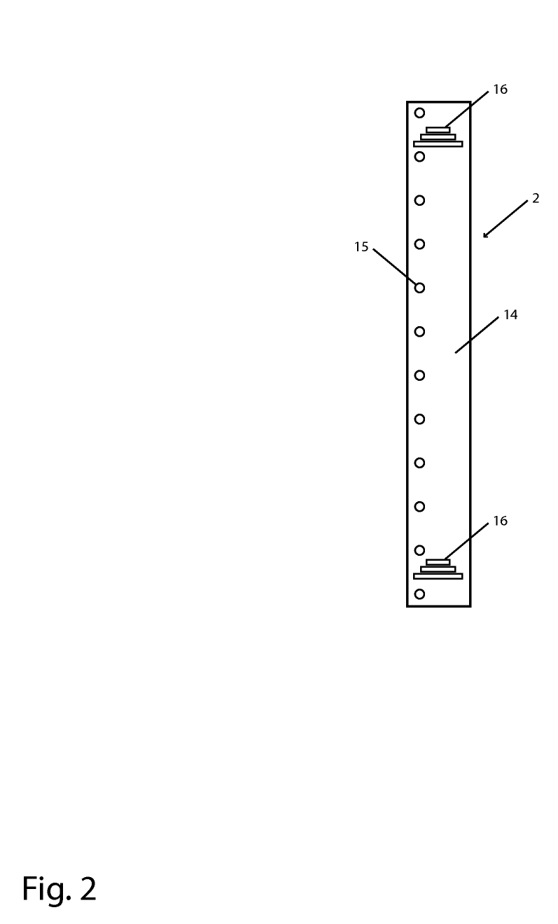

Referring now to FIG. 2 The kiosk is comprised of outer casing 2 that covers the side of the kiosk and will contain an advertising area 14 that can be used for advertisements or a graphic print and will have the option to contain lighting 15. In order to maintain an adequate temperature within the kiosk enclosure there may be vents 16 on the casing 2.

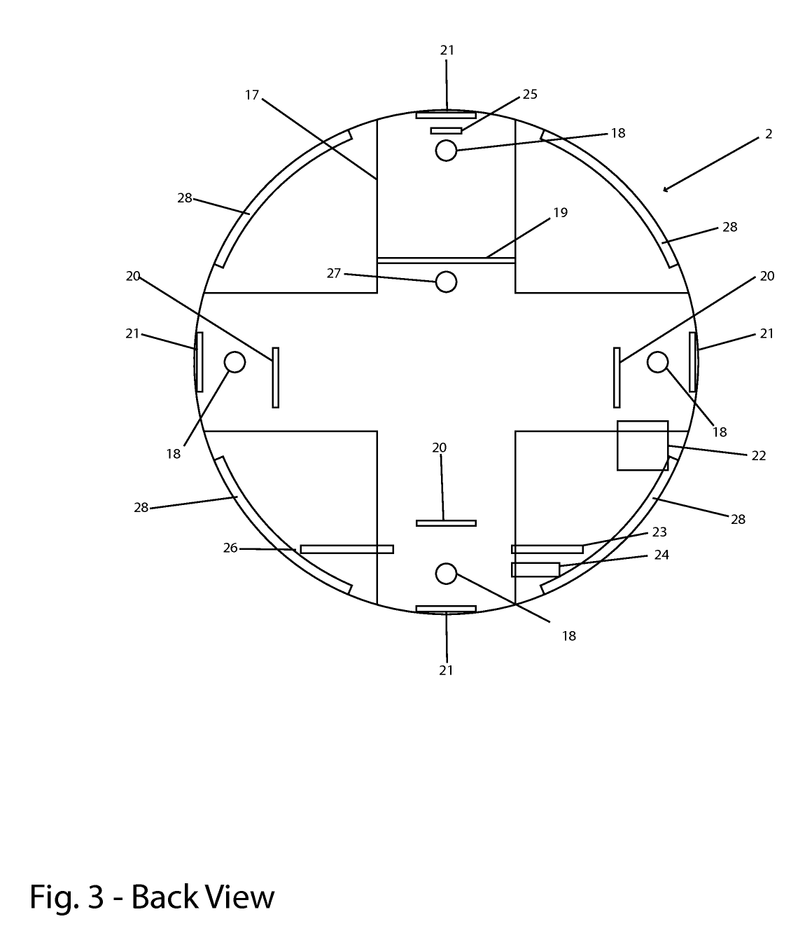

Referring now to FIG. 3 The kiosk can be wall mountable and is done so by utilizing the mounting & support panel 17 that contains mounting holes 18 and is attached to the outer casing 2. The mounting & support panel 17 contains a number of brackets to secure the components within the kiosk. The following brackets will secure the specified components: computer bracket 19, monitor bracket 20, casing support bracket 21 which will securely fasten the mounting & support panel 17 to the casing 2, UPS bracket 22, payment & identification device bracket portable digital storage device bracket 24, light/flash bracket 25 and printer bracket 26. In addition to the mentioned brackets the kiosk will contain an option for a camera and microphone mount 27 as well as internal lighting 28.

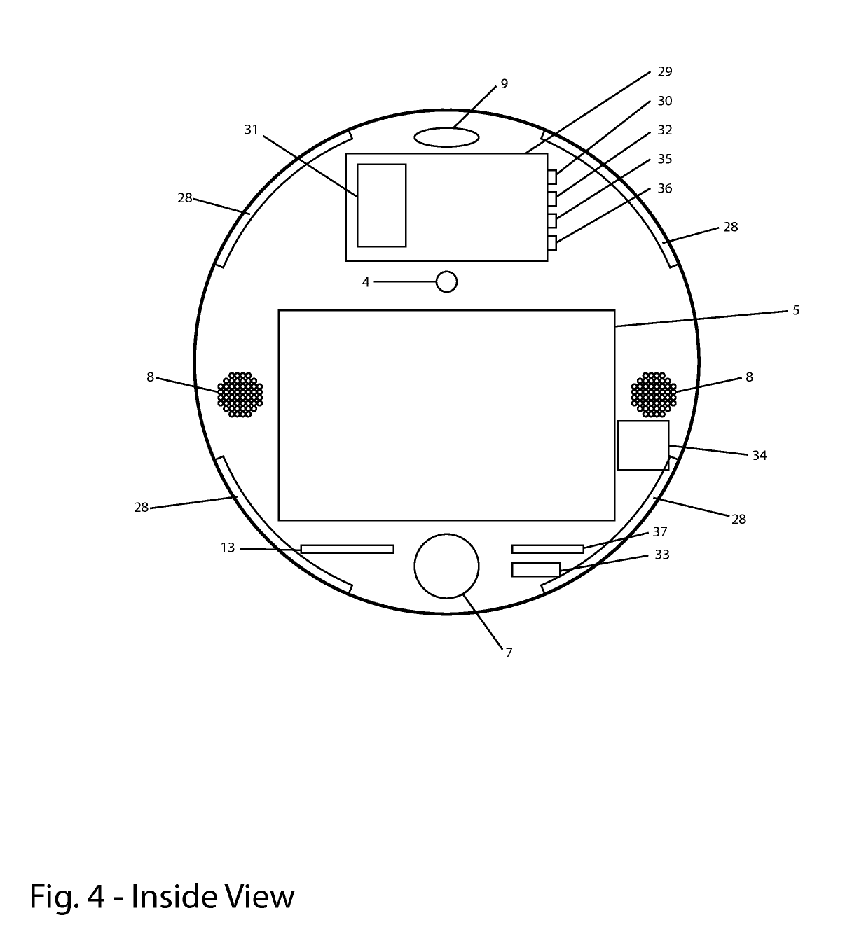

Referring now to FIG. 4. The kiosk can but will not be limited to containing the following components: A computer 29 can process all of the information being received from users and data being transmitted by a central server with the use of a microprocessor or CPU, logic board, video card, RAM (memory), and data storage device 31. The computer 29 can be accompanied by a wireless communication device 30 including but not limited to TCP/IP, wifi, Bluetooth, and WiMAX, 3G CDMA, 4G. A data storage device 31 allows storage of the operating system, software programs, device settings and configurations, user authorization credentials and all media content captured by the kiosk. The option to have wired communication including but not limited to Ethernet and fiber optic 32 can be made available. Device inputs 36 will allow for additional components such as a Global Positioning Satellite to be connected to the computer 29. The touch screen capable monitor 5 will have the ability to display video, pictures, and text captured by the camera and microphone 4 and receive user input via touch. A light/flash 9 can provide additional light for low light situations. The speakers 8 will maintain audio recording and output. The human interface device 7 can be used to initiate and navigate the media recording session and interact with content on the kiosk. The portable storage device 33 will allow users the ability to upload and download content from the kiosk. The printer 13 provides for immediate printing of content for the user and a payment & identification device 37 will have the ability to accept payments and identify users based on an already existing profile. The kiosk may be internally lit 28 to provide aesthetic appeal and easy visibility. The AC power input 35 will be used to provide the power needed to run the components of the kiosk. A UPS 34 will protect all the electronic components from losing power during an outage or loss of electricity.

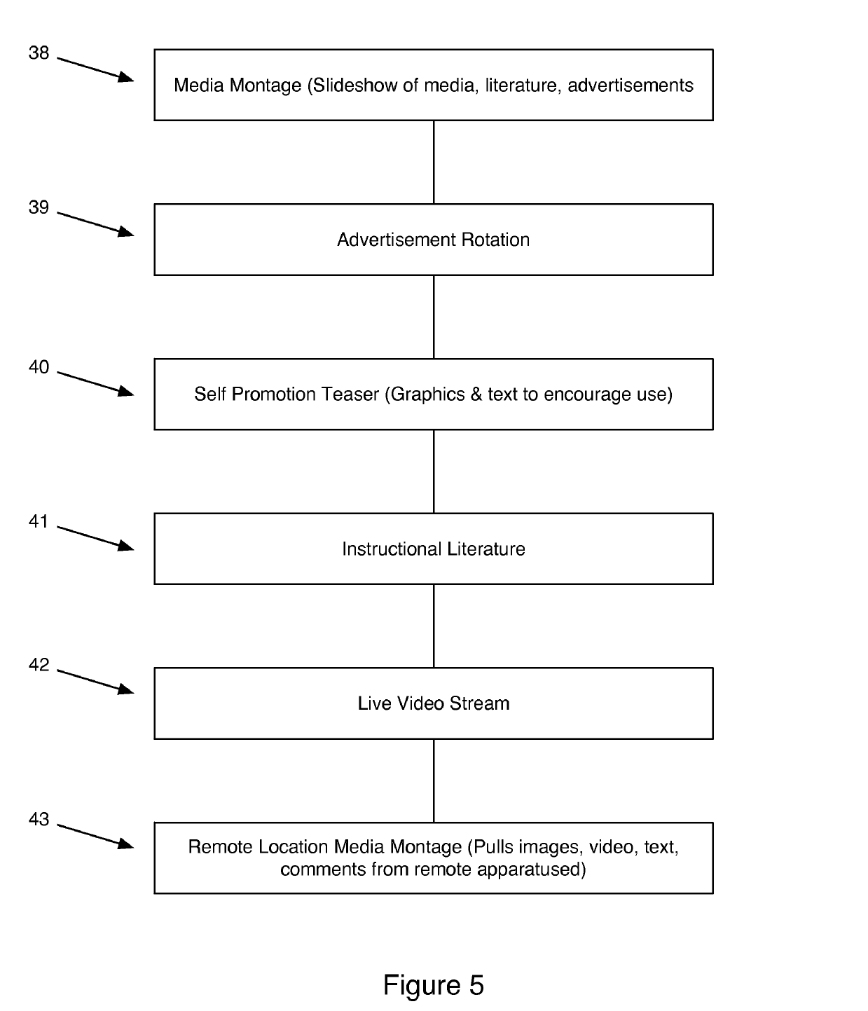

Referring now to FIG. 5, Users will be able to view and listen to content from the kiosk. The media montage 38 displayed on the monitor will contain a variety of slideshow options including images, video, sound, literature and advertisements from the physical location of the specific kiosk. In one embodiment the monitor may have rotating advertisements 39. The kiosk may have self-promotion teasers 40 containing text and graphics to encourage user interaction. There may be periodic instructional literature 41 to assist users when interaction with the kiosk. Users may be able to stream live video 42 from kiosks across the world and communicate with each other in the form of live text, audio and video chat or conference. Similar to 38 there may be a remote location media montage 43 which could contain a variety of slideshow options including images, video, sound, literature and advertisements from remote locations around the world. The content of the slideshows may be filtered in several different ways including but not limited to, highest rated, most viewed, latest submissions, locations, random selection, most commented and other user contributed criteria through the web interface.

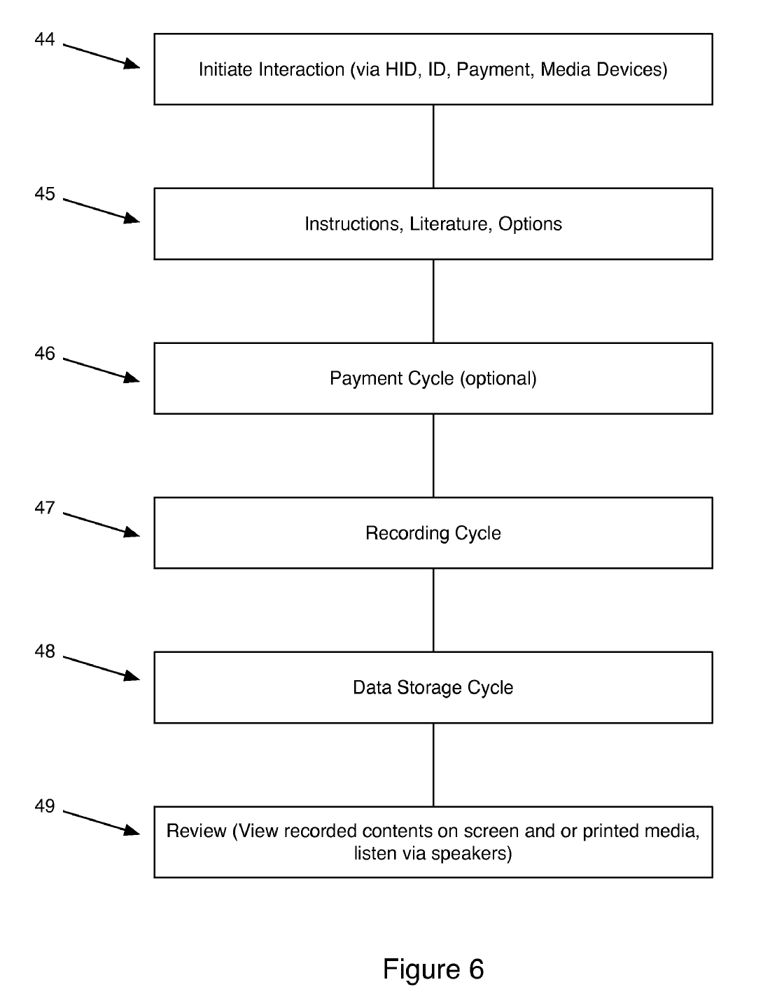

Referring now to FIG. 6, Users will also be able to interact with the kiosk and in one embodiment can initiate the interaction 44 either through touching the kiosk on the human interface device, touch screen capable monitor, payment & identification device, media devices, triggering a motion device/camera or voice activation which will be received by the speakers. Upon the initial interaction the user may be presented with instructions and literature with optional decision-making 45 which could include authentication, registration, media recording options, legal disclaimers and options to cancel the session. In one embodiment the user may be prompted to submit payment 46 and following receipt of payment the recording cycle 47 will commence. The data storage cycle 48 will store the user-generated content to media storage device of the kiosk. Users will then be able to review 49 the recorded content before it is displayed on the media montage and may have the option to accept or reject approve/disapprove permanent storing and uploading. The kiosk will return to idle mode and display one of the various options mentioned in FIG. 5.

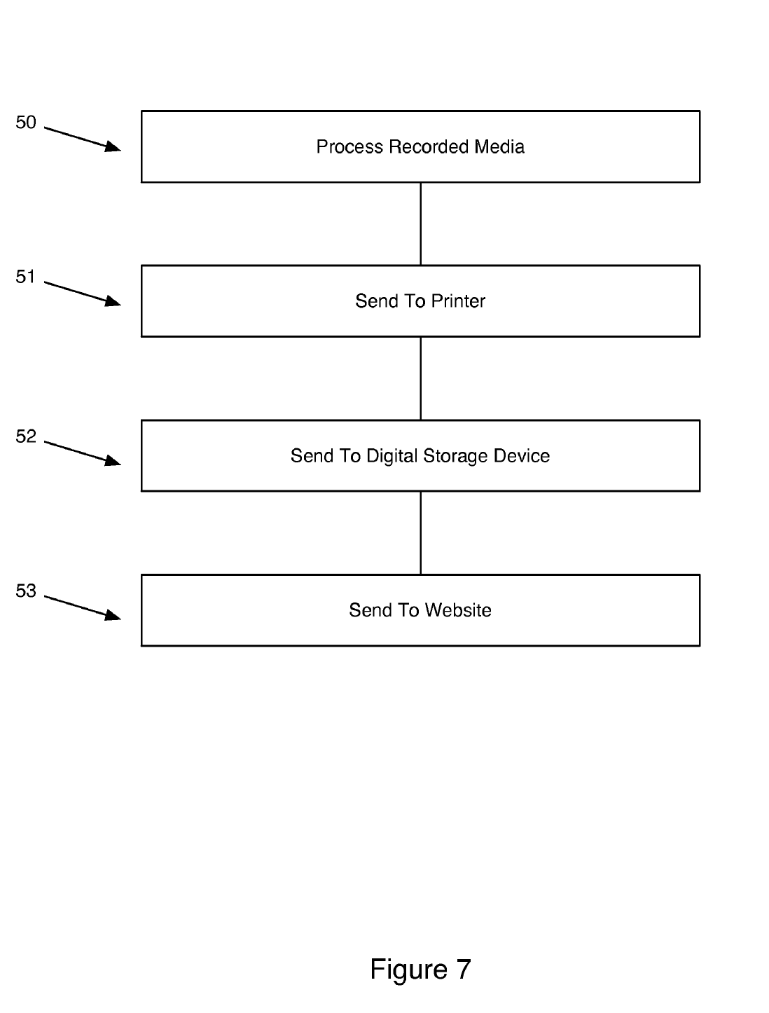

Referring now to FIG. 7, The kiosk will have the ability to perform a sequence of automated actions in which no user input will be required. After the kiosk records media content and is approved by the user, it will then automatically process the recorded media 50. If the recorded media is a picture then it may be sent to the printer 51. All recorded media will be sent to the data storage device 52 and or personal storage device—usb drive, flash memory etc. after which it will also be sent to the website 53.

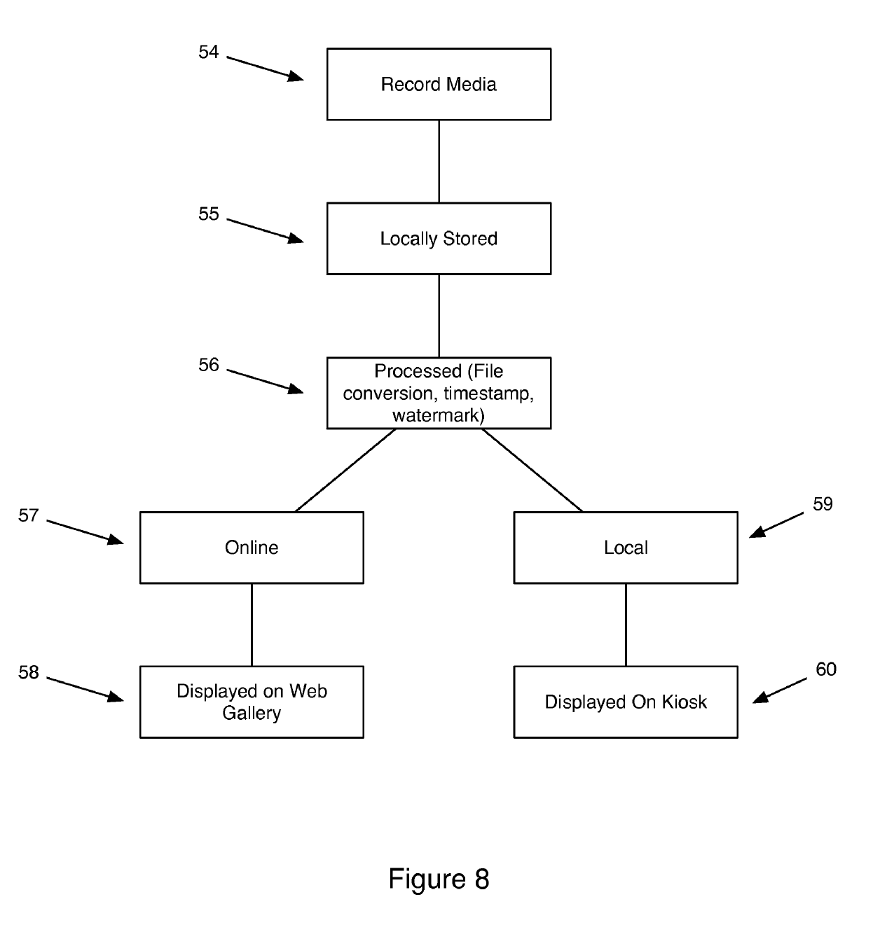

FIG. 8 depicts the stages from recording media to it's delivery. 54 is the recording stage in which it is then digitally stored locally 55 within the apparatus media storage device. 56 is the processing of the recorded media in which conversions, categorization, optimizations, enhancements, local and remote archiving is performed on media. Such features may include file conversion to various formats to be compatible with different playback devices, timestamp for archival purposes, and watermarking information, advertisements, and logos directly onto the media. 57 shows the storage of the processed media online for retrieval. 58 is the media gallery in which recorded media is organized and viewable to website users. 59 shows the storage of the processed media on the kiosk itself for instant viewing. 60 depicts the locally stored media in which it is broadcast on the kiosk apparatus display in the form images, videos, audio or data.

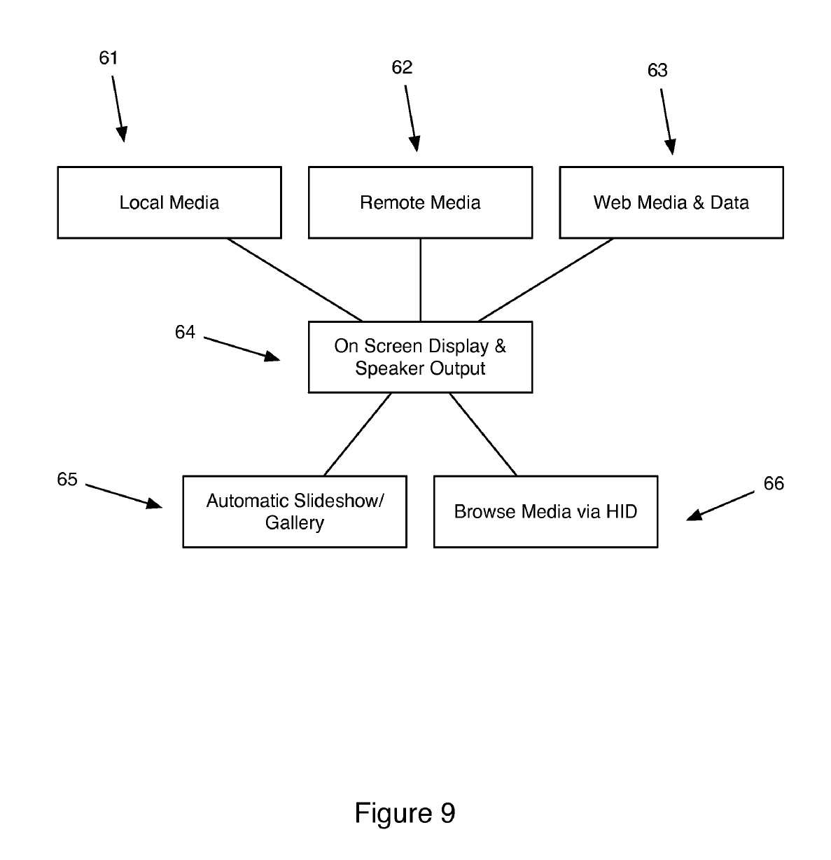

FIG. 9 specifies the process of retrieving media and data from various sources and displaying them on the apparatus. 61 is the collection of local pre recorded media, 62 represents media recorded from other kiosks within the network, 63 depicts media and data from the central online database of recorded media. 64 depicts the broadcasting medium contained within the apparatus including but not limited to a monitor, display, screen, and speakers. 65 is one embodiment of displaying media utilizing an automatic slideshow which takes various sets of organized or random media and displays them in sequence also known as a gallery or slideshow. 66 represents the kiosk's ability to receive human interaction and display media based on a users preference. A user can browse media utilizing a Human Interface Device from the local kiosk, remote kiosks, or from the online network.

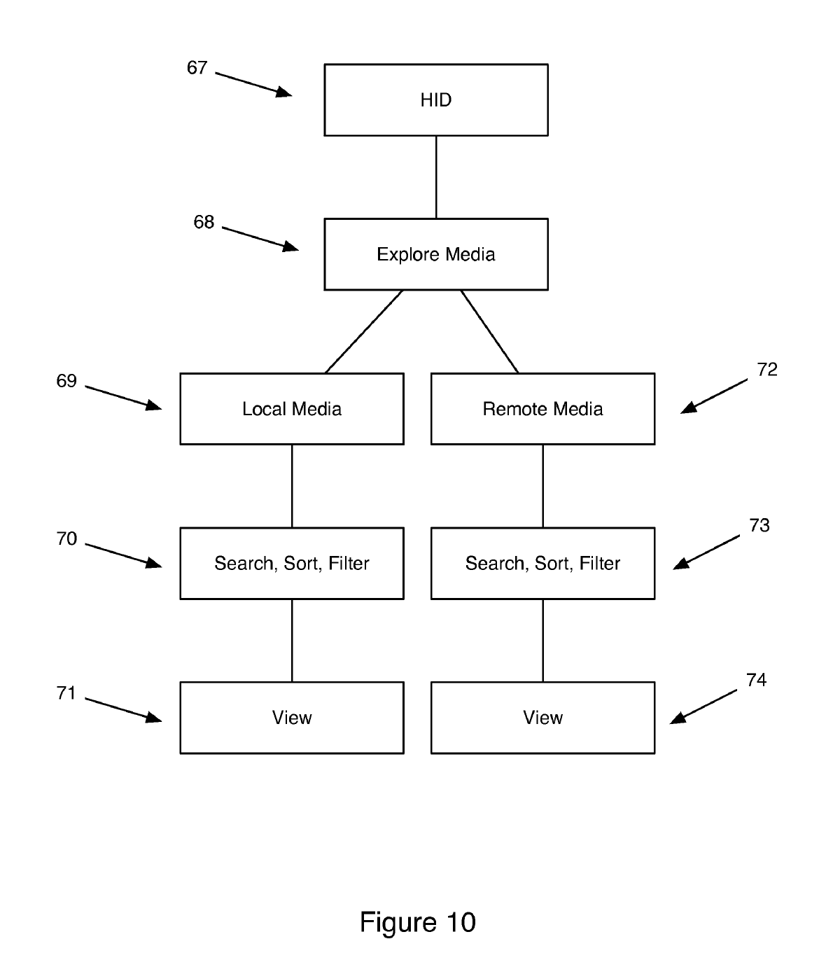

FIG. 10 takes browsing of media as seen in 66 into finer detail. 67 depicts a Human Interface Device (HID) such as, but not limited to, a keyboard, mouse, button, controller, touch screen or other means of controlling input. The HID enables human interaction to control aspects of the kiosk. 68 depicts the option chosen by the HID to explore and browse media locally or remotely. 69 is the local browsing option which lets a user view media previously recorded from the current kiosk. The ability to search, sort, and filter media is possible with the options as seen in 70. Various options and filters can be used to find media such as, date/time recorded, category, rating, number of views and more. Once the search or filter has been applied, the content is delivered for viewing on-screen and or listening to on the speakers as depicted in 71. Remote media can also be browsed as depicted in 72. Remote media consists of media recorded from other kiosks within the network, and or content from the kiosk network's central website. Finding media through various methods such as searching, sorting, and filtering by location, date/time, category, popularity and others is represented by 73. As with the local viewing option, viewing remote media on the display and listening via the speakers is depicted in 74.

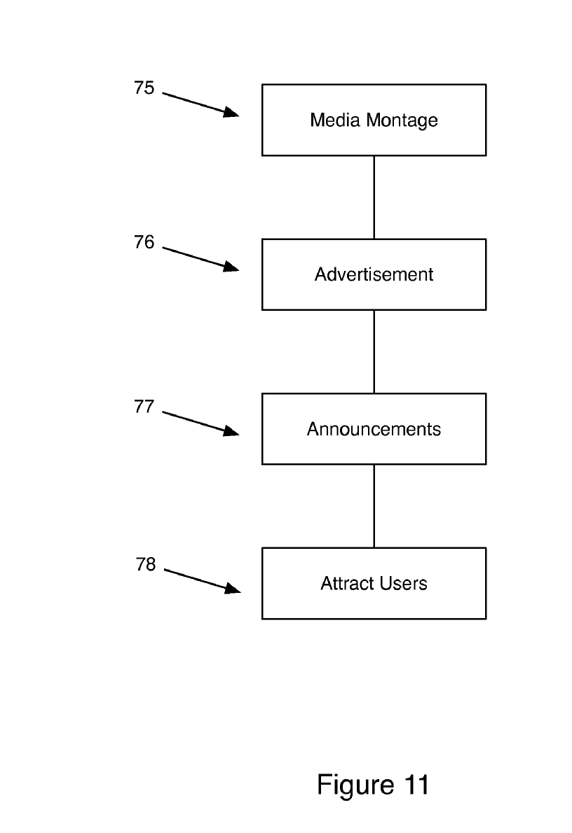

FIG. 11 shows the various automated forms in which information, data, and media are displayed on the kiosk, requiring no user input or interaction. This can also be described as “idle mode”. Broadcasting is one of the key functions of the current invention. The media montage as shown in 75 is an automatic blend of broadcasting media in various formats such as a slideshow, video, scrolling, panning, zooming, fading of images video and sound. Advertisements are periodically broadcast in many forms including but not limited to an on screen overlay, full screen video, scrolling image, animation or audio interruption as depicted by 76. A kiosk administrator or the like may want to broadcast an announcement 77 such as a notification, special, operating hours and any other information directly on the kiosk. These announcements are created, updated, modified, and removed by utilizing the web interface further described in the patent. From time to time, the kiosk may show a screen, video, animation, utilized to attract people as seen in 78 to use it.

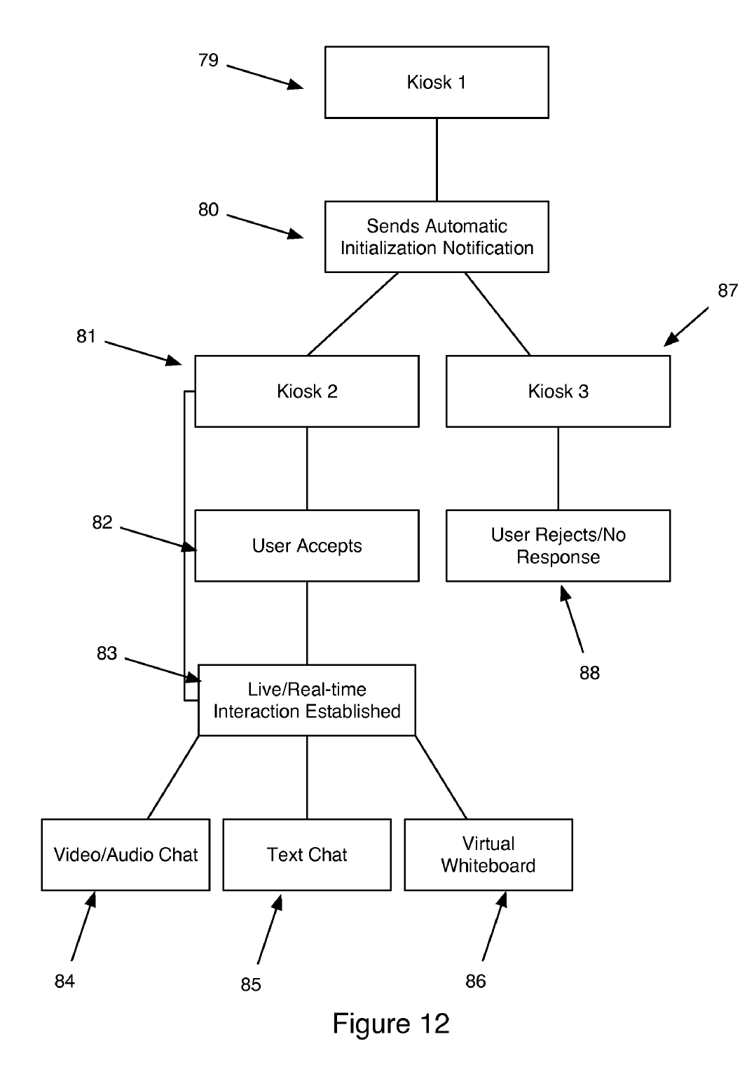

FIG. 12 describes a novel part of the present invention in that the kiosks are able to directly communicate to other kiosks within the network. The following scenario describes how a kiosk may automatically send an impromptu interaction initialization request to another kiosk. 79 is a kiosk located in a Texas arcade. It sends an automatic initialization notification to other kiosks within the network as seen in 80. Kiosk 81 located at an arcade in California receives the communication request from Kiosk 1. If a user of Kiosk 2 accepts the communication request 82, a connection is established 83 where in Kiosk 1 and Kiosk 2 are able to have a live real-time interaction. The interaction includes, but is not limited to video/audio chat 84, text chat 85, or even a virtual whiteboard 86 in which there is a shared screen for communicating via drawing and writing. 87 represents a kiosk in which there was no response or a request was rejected 88.

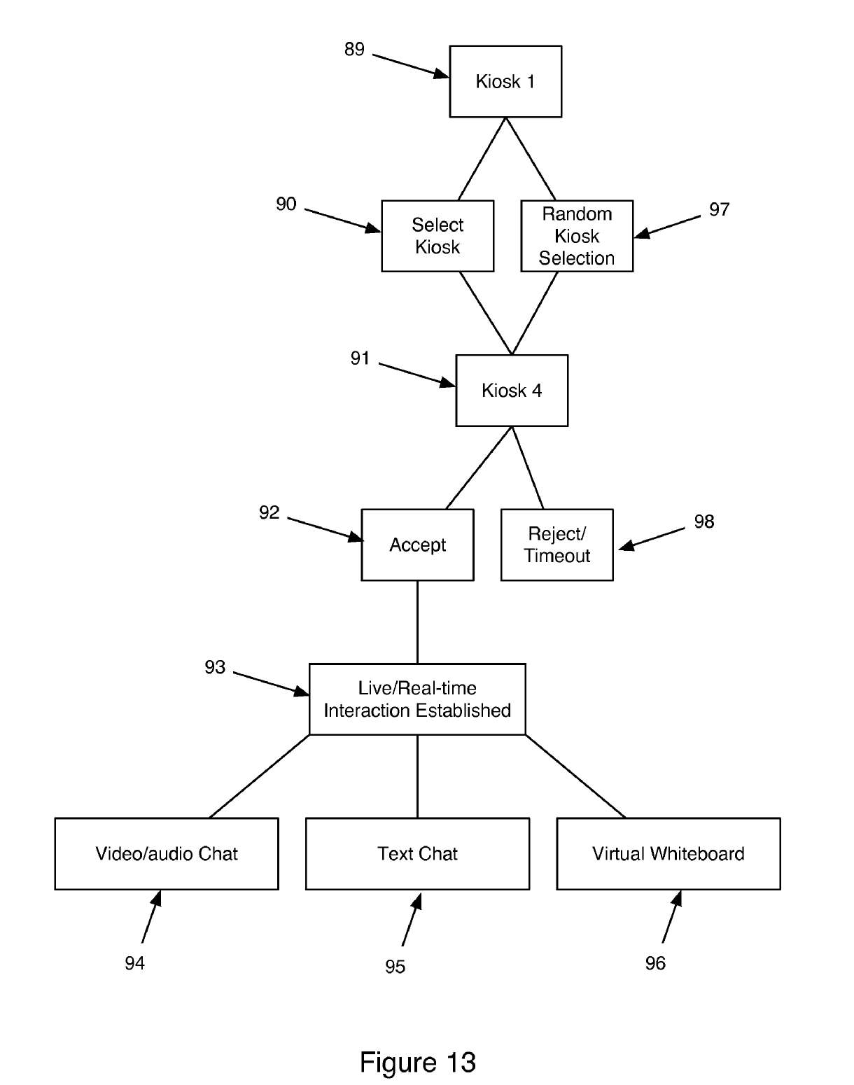

FIG. 13 describes an alternate method and novel part of the invention for direct kiosk to kiosk communication. 89 depicts a kiosk in which a user chooses to initialize communication to another kiosk within the network. Two options are presented to the user in which he may either select which kiosk he wished to communicate with as shown in 90, or let a kiosk be chosen at random 97. In either case, for simplicity, we'll assume 91 Kiosk 4 has been chosen. A user at Kiosk 4 is presented with the option to 92 accept, or 98 reject the request. 98 also depicts cancellation of the request by not accepting within a time limit. If the connection is accepted, a 93 live, real-time interaction is established and users from Kiosk 1 and Kiosk 4 can begin communication in the following ways. A 94 video/audio chat will allow users at both kiosk to see and hear each other on the display and speakers. They also have the ability to type and text chat 95, or share a virtual whiteboard 96 to communicate in the form of drawing and writing on the kiosks HID or touchscreen display.

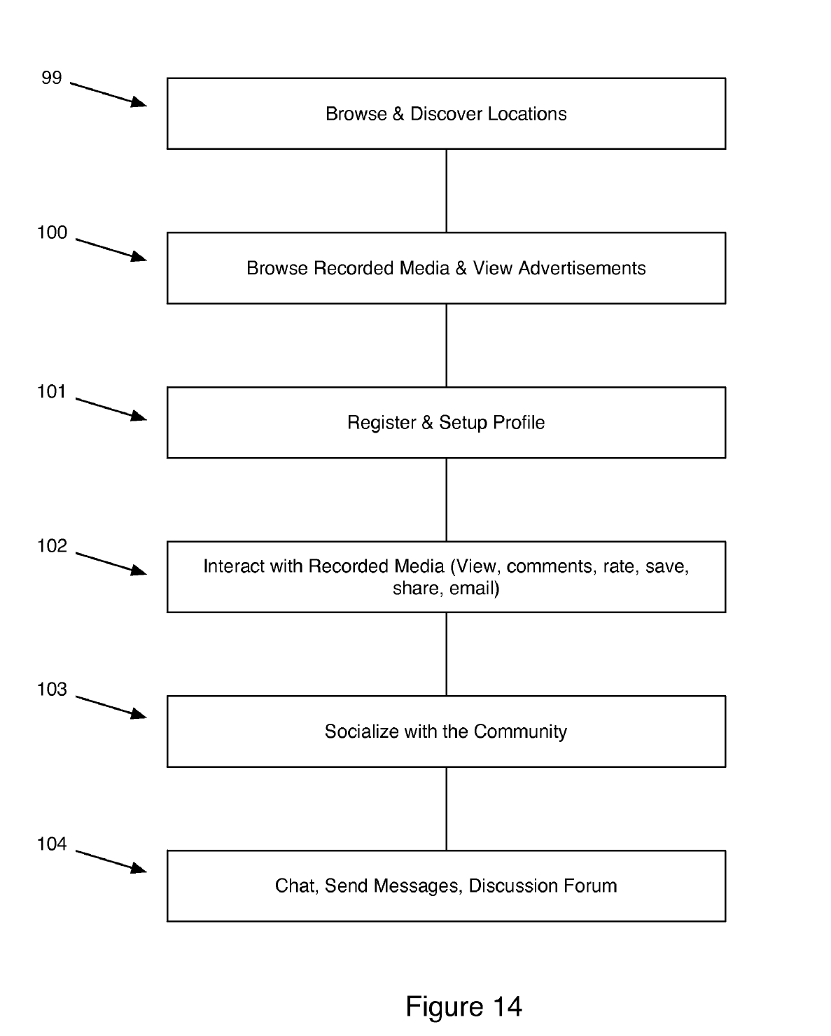

Referring now to FIG. 14, Users will be able to interact with the website in various ways. Browsing & discovering locations 99 that contain kiosks will be useful for people that would like to locate an establishment to visit and interact with a kiosk. Browsing, viewing and listening to recoded media and advertisements 100 will allow for an easy way for users to look at and listen to all content that has been submitted from the network of kiosks to the website. Users will have the ability to register and set up a profile 101 which will allow them to add personal information to their profile which can be shared with other users. Once a user has set up a profile they will have the ability to interact with the recorded media 102 in the form commenting, rating, sharing, email recommendations and bookmarking content to their profile. These registered users will also be able to socialize with the online community 103 by searching, filtering and interacting with other users. Registered users will also be able to chat, send messages, and participate in an online discussion forum 104.

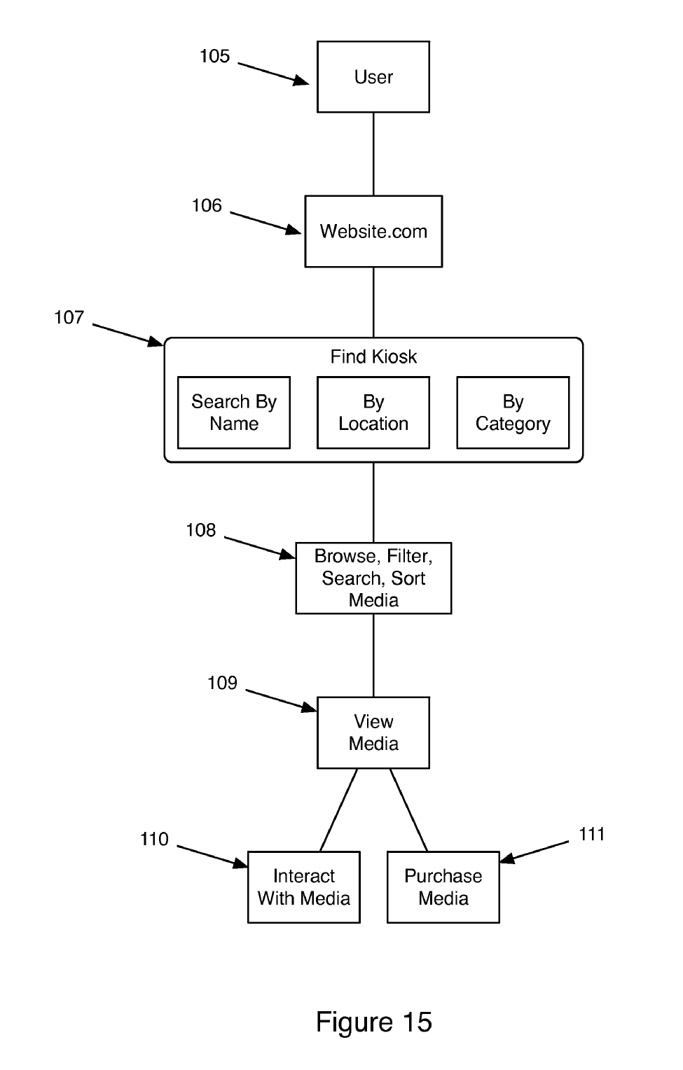

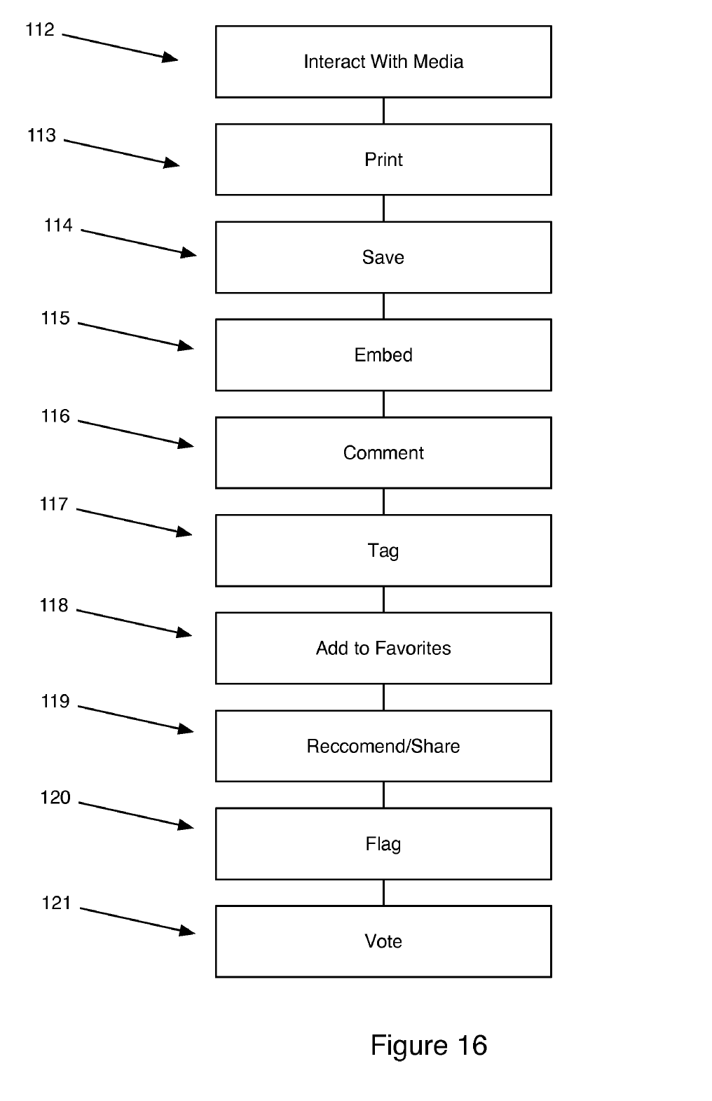

FIG. 15 describes how users are able to interact with media recorded from a kiosk via the central website. The ability to browse, locate and interact with recorded media is a novel part of the present invention. The following scenario describes a common use embodiment of the system and method of this invention. 105 is a user with an internet or network enabled device who wishes to interact with the media by first connecting to the network's central database 106. Once connected, they have the option to locate media in a number of methods. They are able to find a specific kiosk within the network as shown in 107 by entering the name of the establishment or event hosting the kiosk, choosing a kiosk based upon it's geographic location, or by choosing different categories within the network. Once a kiosk has been located and selected for viewing, they are presented with options to 108 browse, filter, search, and sort media within the current kiosk selection. Date/time, category, popularity are some examples a user can further narrow their search within a kiosk and view the resulting media 109. A novel part of the current invention is the ability to 110 interact and 111 purchase media recorded from a kiosk. Interaction includes but is not limited to, commenting, rating, saving, storing, downloading, printing, recommending, and more which will be described in further detail. Purchasing media directly from the website enables users to instantly acquire media such as premium content, higher quality versions, extended versions, or purchase-only content. FIG. 16 describes media interaction from any network enabled device as stated in 110 in further detail. The ability to directly interact with media recorded from kiosks within the network is a novel part of the current invention. The synergy of a dedicated social media recording device and it's online social network community counterpart is what defines the novelty of the current invention. A way to imagine the current invention is a “Facebook Machine” or “Flickr Machine.” No apparatus exists to solely function as a dedicated media generator, media broadcaster and interaction device for a specific social network or online community. Interacting with media 112 is the basis in which a social network and community is built. The ability to 113 print kiosk recorded media gives users the ability to create tangible photographs or images. Users can also 114 save media onto their computer or network enabled device for offline viewing and portability. 115 provides embedding codes and or links for users to easily share the content with other websites, networks and the like. The ability to comment 116 on media is the basis of creating the social portion of the current invention. Users can state their opinion, say hello, and get an opportunity to carry conversations back and forth. The current invention allows indirect communication with people from all over the world. A tag 117 is a term which is used to freely categorize things in a computer setting. Some example tags could be, sports, funny, crazy, cute, celebrity, John Smith and any other descriptive forms of categorization. This feature enables users to filter media based on applied tags. 118 lets a user add media to their favorites within their online profile for quickly locating in the future and storing in their personal catalog also known as bookmarking. 119 allows for users to conveniently recommend media to their friends and family by sharing a link in the form of an automatically generated email or personalized private message to the recipient of their choice. 120 is a flag feature which provides a means to mark a piece of content as inappropriate or offensive and thus notifying the network administrator of such problematic media for review. The media can then be unpublished or deleted from the system if required. The ability to 121 vote on media brings many possibilities to the community and the broadcasted content on the kiosks. For example, a kiosk could display the “top ten pictures” as voted by the users in the community.

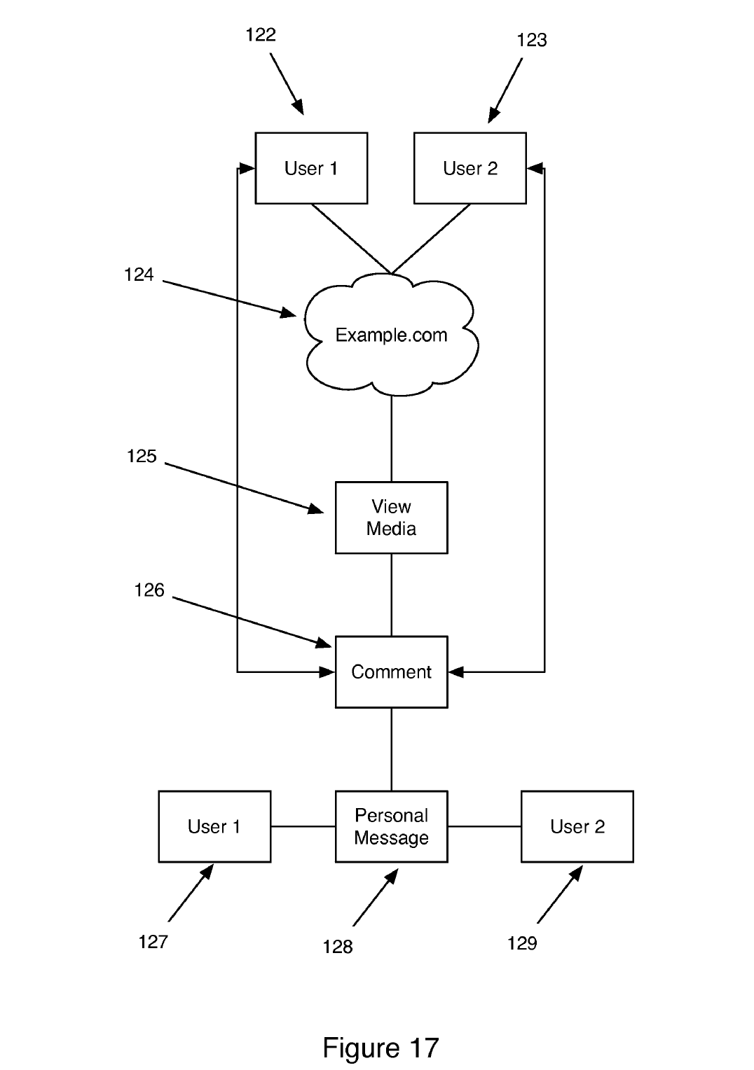

FIG. 17 depicts an example of meeting and directly interacting with other users of the network via the interest in a comment. User 1 122 and User 2 123 have both visited the network's central website 124 to view media 125. User 1 122 has posted a comment 126 on said media in which User 2 123 responds with a comment of her own. They may go back and forth and carry on a conversation within the comment portion, or they can choose to send a 128 personal message, thus creating a direct and private means of communication within the private messaging system held by 127 and 129.

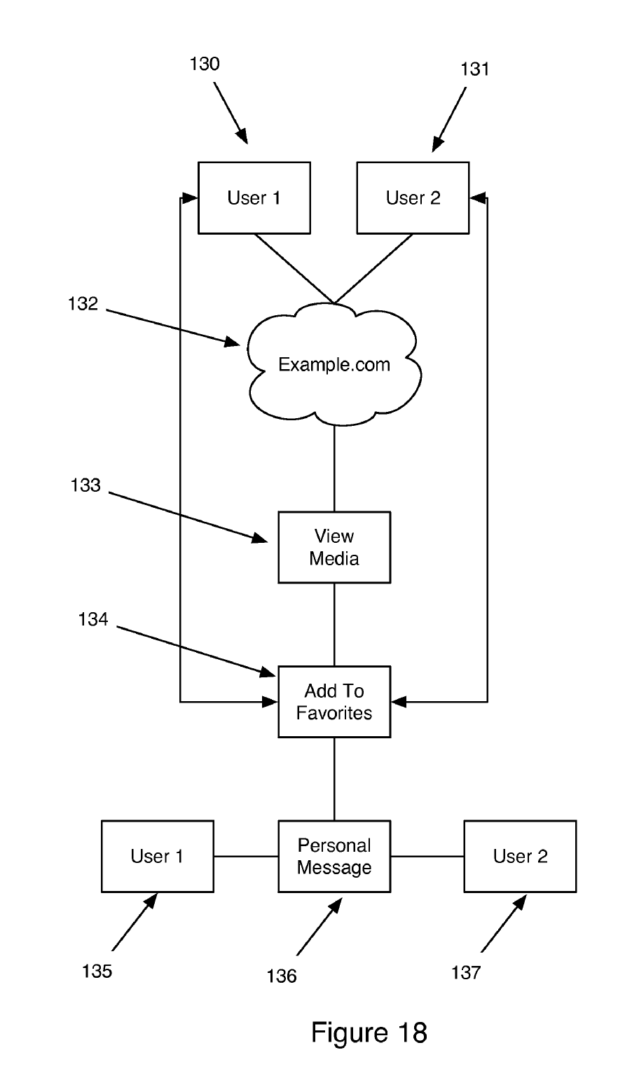

FIG. 18 depicts another example of establishing direct contact or taking a liking to another user by sharing interest in media. User1 130 and User 2 131 visit the network's central website 132 and view some media 133. User 1 had previously added said media to his favorites 134. User 2 131 really likes said media and notices that User 1 has added it to his favorites. User 2 has taking a liking to User 1 based on similar interest in said media. User 2 decides to 136 send a personal message to User 1. Now User1 135 has received and responded to User 2 137 and now they have direct communication.

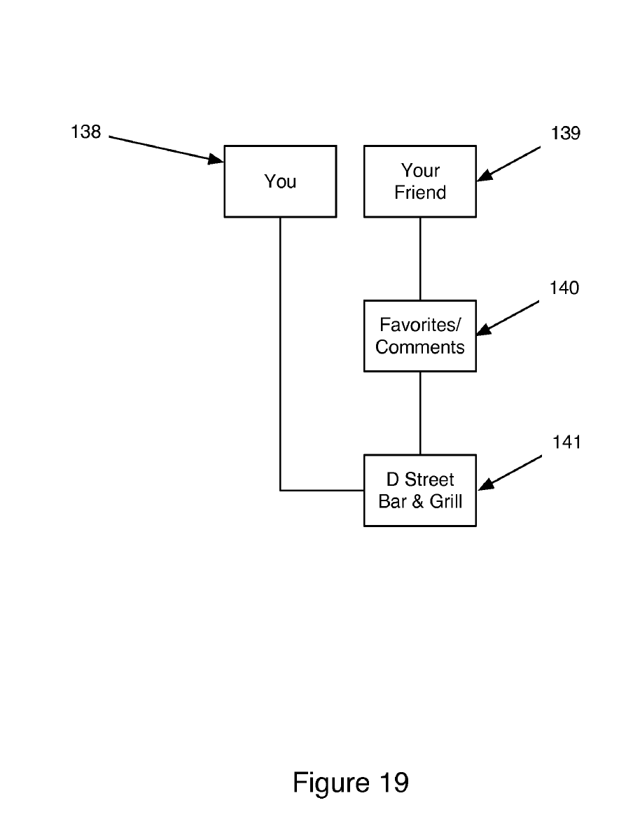

FIG. 19 depicts a recommendation on an establishment in which a kiosk is hosted to a user of the network. You 138 receive an automatic recommendation from 139 your friend to check out the establishment D Street Bar & Grill 141 because your 139 friend has 144 added it to his favorites, or has commented on it. Another recommendation method is to view 139 your friend's profile and see who he has 140 added to his favorites or commented on.

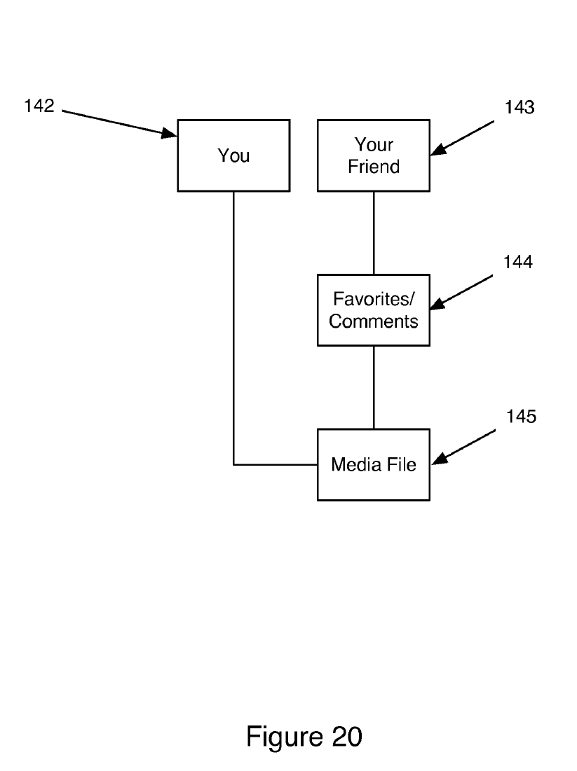

FIG. 20 shows how media can be recommended to you based upon your friend's interest in said media. You 142 may view your friend's 143 profile and view a list of content that he has 144 commented or added to his favorites. Therefore, such media files 145 may be of interest to you.

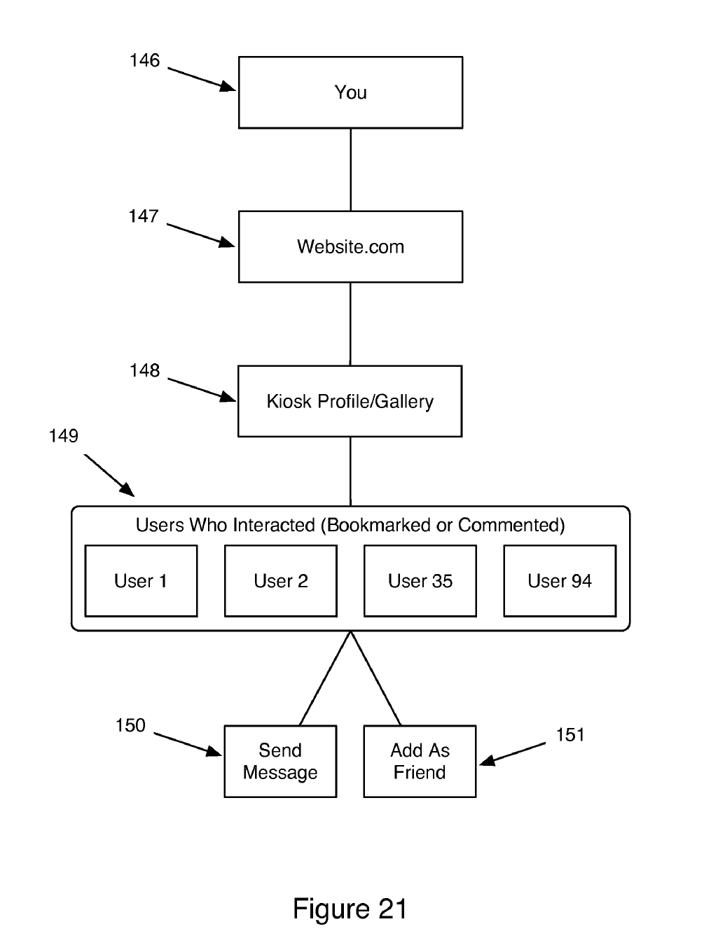

FIG. 21 shows how the invention's system and method can be used in which humans can make friends and find people of similar interest via the current invention's apparatus and network. In one embodiment, 146 you visit the network's central website 147 and navigate to a kiosk's profile/gallery 148. You then proceed to see that several users have interacted with the kiosk's profile/gallery 149. These users may have commented, rated, or added said kiosk's profile to their favorites. Having liked the establishment in which said kiosk was installed, you take a similar liking and interest as the other users depicted in 149. You then may proceed to 150 send a message to a particular user and or 151 add them as a friend to your profile.

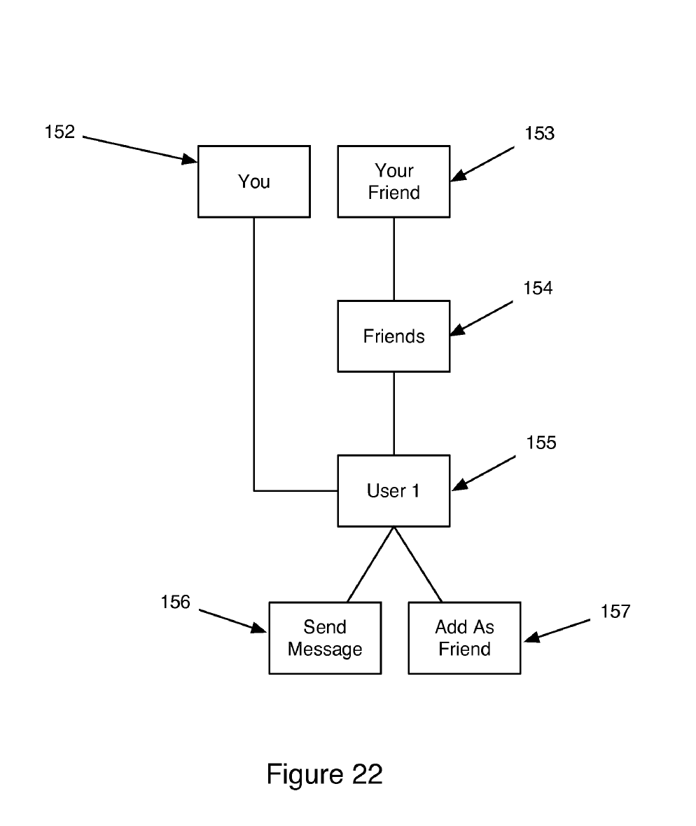

FIG. 22 depicts another method in which the current invention can assist in meeting people and increasing your network of friends on a personal level. You 152 view your friend's 153 profile and see his list of 154 friends. You recognize someone you haven't talked to in a while, User 1 155. You may then choose to 156 send him a message, or 157 add him as a friend to your profile.

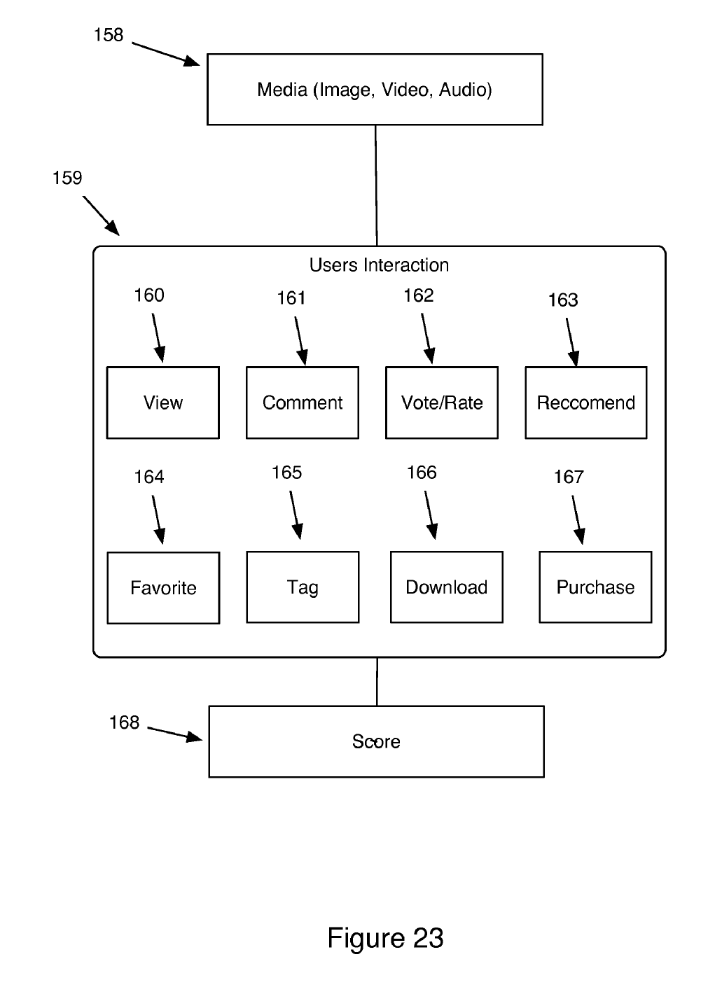

FIG. 23 shows a variety of methods in which constitute media as being popular which can then be automatically organized into relevant dynamic galleries to be viewed on the kiosks and the network website. 158 depicts the media in which has been interacted with in several ways in 159. These interactions are calculated to determine a score which is then used to determine it's popularity and ranking. Every time media is viewed 160, it is recorded incrementally. Then number of comments 161 for a particular piece of media is also recorded. Users can vote and rate content 162 which gets calculated into a total rating score. The more people 163 recommend media, 164 add it to their favorites, 165 tag, 166 download, or 167 purchase, the higher the score is. Each interaction has it's own individual score and also a total score of the sum of points 168, helping determine the popularity of media. This scoring system greatly enhances the inventions ability to intelligently create automatic galleries of interesting content to be displayed on the apparatus' and on the network website.

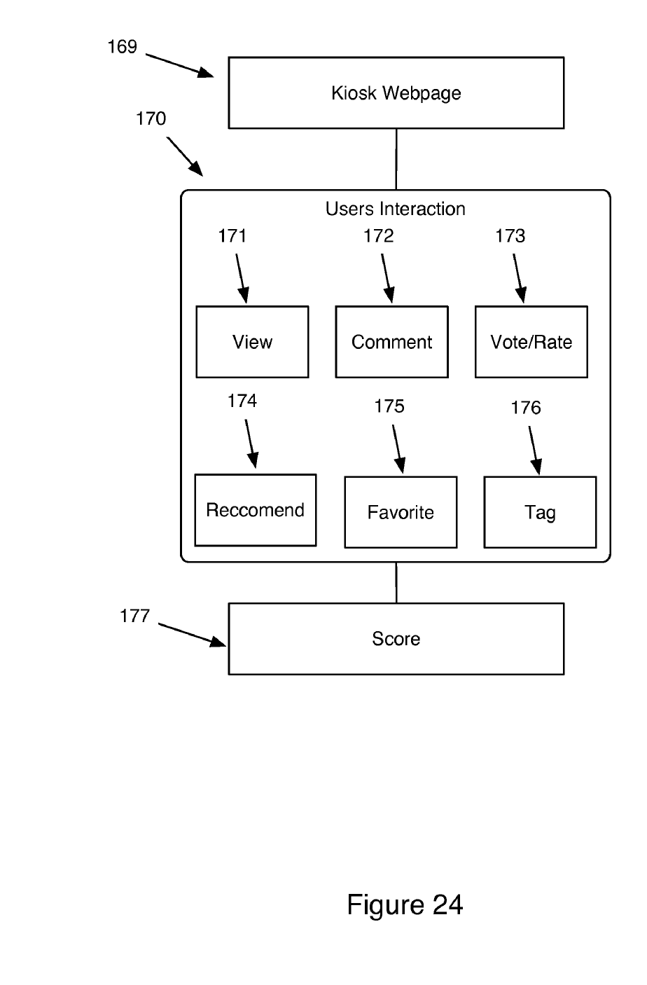

FIG. 24 shows a variety of methods in which constitute a kiosk's host establishment or event's popularity and ranking Users viewing the 169 Kiosk's webpage, can interact 170 to determine the popularity and ranking. These interactions are calculated to determine a score which is then used to determine it's popularity and ranking. Every time the kiosk's web page is viewed 171, it's recorded incrementally. Then number of comments 172 for said kiosk page is also recorded. Users can 173 vote and rate based on a ranking system. The number of 174 recommendations, 175 times added to favorites, and tags 176 is also calculated into the total score 177. The higher the total score, the more popular and higher ranking the kiosk gets. No current inventions allow these interactions to a media recording kiosk and it's associated host.

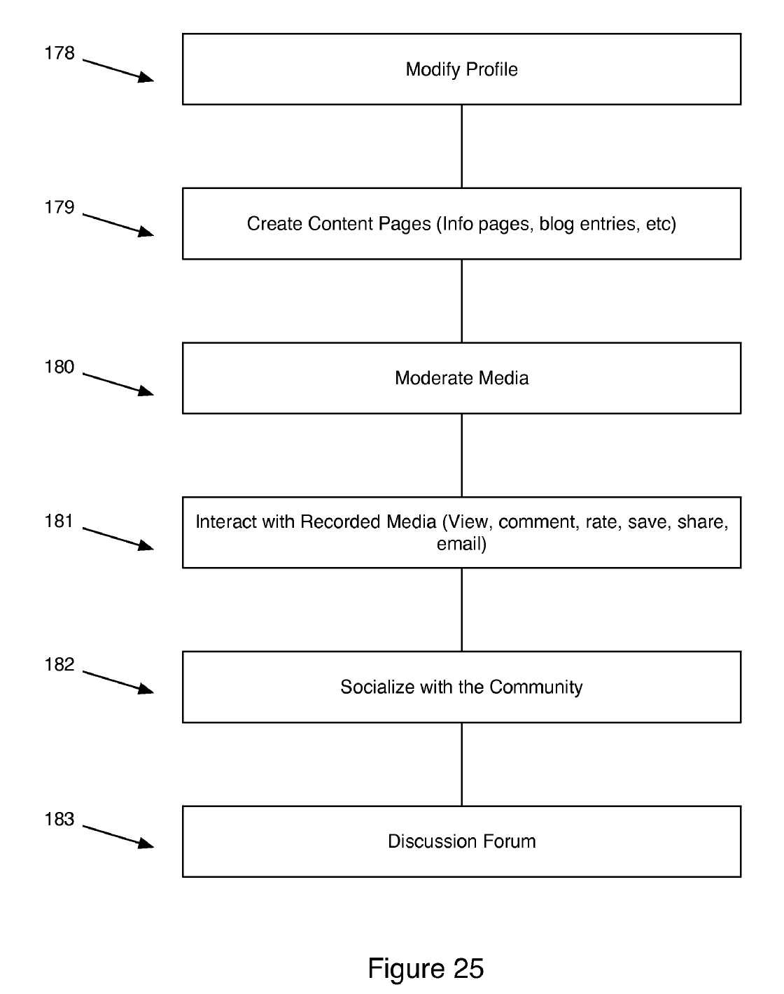

Referring now to FIG. 25, All establishment and location managers that host kiosks will have the same capabilities as the registered users mentioned in FIG. 14 and in addition to the ability to modify and customize their content and profile 178 on the kiosk and online profile pertaining to their specific location. Managers will have the ability to create content pages 179 that could include text, images, audio and video. This information will be broadcast online as well as on the kiosk at their location or within the kiosk network. The ability to moderate media 180 such as removing unwanted content and recorded media will be available to location managers. Location managers will have the ability to interact with the recorded media 181 in the form commenting, rating, sharing, email recommendations and bookmarking content to their profile. Location managers will also be able to socialize with the online community 182 by searching, filtering and interacting with other users. Location managers will also be able to chat, send messages, and participate in an online discussion forum 183.

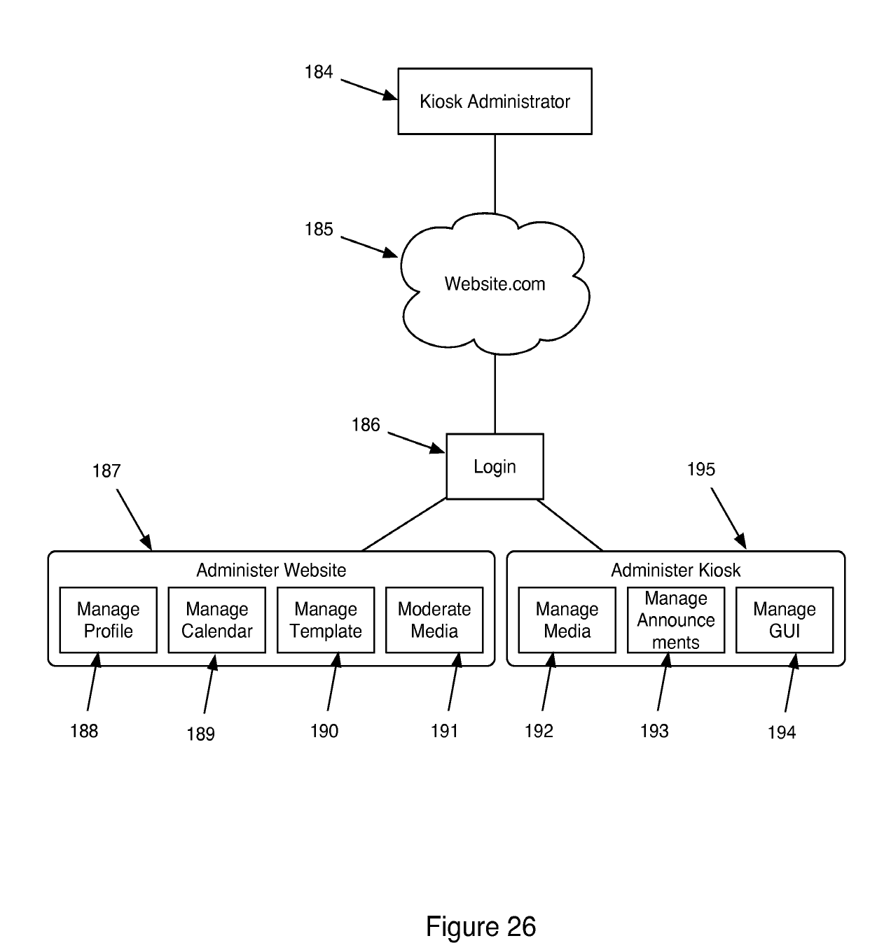

FIG. 26 depicts another novel portion of the invention for administrators to be able control the look and functionality of the media recording device via a web interface. A 184 kiosk administrator can be the owner, lessee, figure of authority, or delegated person to control and moderate the interface/design, features and functionality, moderate content and recorded media of both the kiosk and the kiosk's associated web page. All of the administration is done via the network's central website interface 185 upon proper login authorization 186. Once authorized, the kiosk administrator can access said kiosks website administration functions 187. Since each kiosk is associated with a physical location, establishment and/or event, they have a unique profile 188 which contains pertinent information among said kiosk. Information may include the name of the establishment or event which is hosting the kiosk, location information, contact information, description, logos, images, video, audio and what categories the kiosk belongs to in the network. All of this information can be accessed via the website and or on a kiosk within the network. A 189 calendar feature enables kiosk administrators to add, edit, remove events that can be shown on the kiosk and the kiosks associated webpage. A remote controlled calendar is a novel part of this invention to be displayed on a media recording and broadcasting kiosk. Kiosk administrators can also manage the website's template 190 to change the design, look and feel of the kiosks associated web page within the network. Another novel part of the current invention is the ability to remotely moderate their recorded media 191 via a web interface. This is useful if they wish to remove an offensive photo or video from the kiosk itself or on their kiosk's associated webpage. Kiosk administrators also have the ability to directly manage the kiosk 195 via the web interface. They can manage media 192 in various ways such as creating custom galleries, slideshows, and featuring specific media to be displayed on the kiosk. This is another novel use of the current invention. Another feature is managing announcements 193 in the form of text, images, video, or audio that will be displayed on the kiosk. No other media recording and broadcasting kiosk has the ability to display customized announcements like the current invention. Another novel use of the current invention is the ability to control the kiosk's 194 Graphical User Interface (GUI) using a web based interface. Background images can be changed, colors, fonts, transition effects, slideshow modes and logos can be customized to change or enhance the kiosk's graphical interface and user experience.

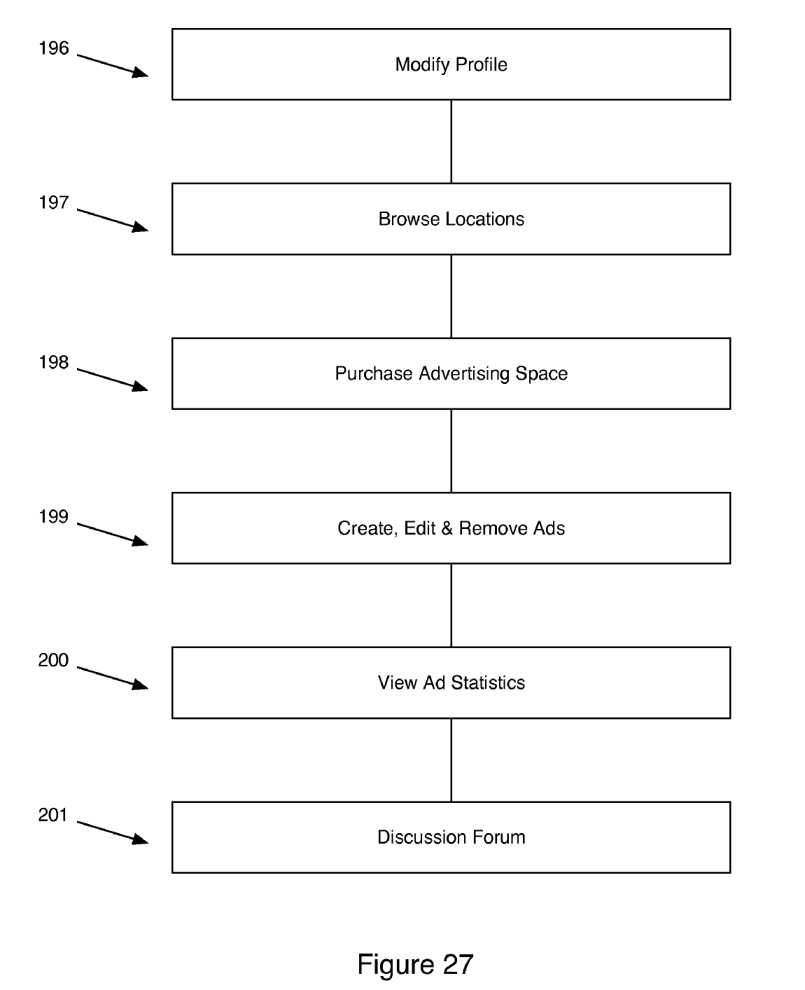

Referring now to FIG. 27, Advertisers will have the ability to interact with the website. They will be able to modify their profile 196. They will have the ability to browse locations 197 that contain kiosks in order determine which locations are the most suitable for them. They will be able to purchase advertising space online 198 to be displayed online and or within the kiosk network. Advertisements can be created, edited and removed online 199 through the web interface. Advertisement statistics for each kiosk as well as online advertising will be available for advertisers to view 200 simply by logging on to the website and entering their profile id. Advertisers will also be able to participate in an online discussion forum 201.

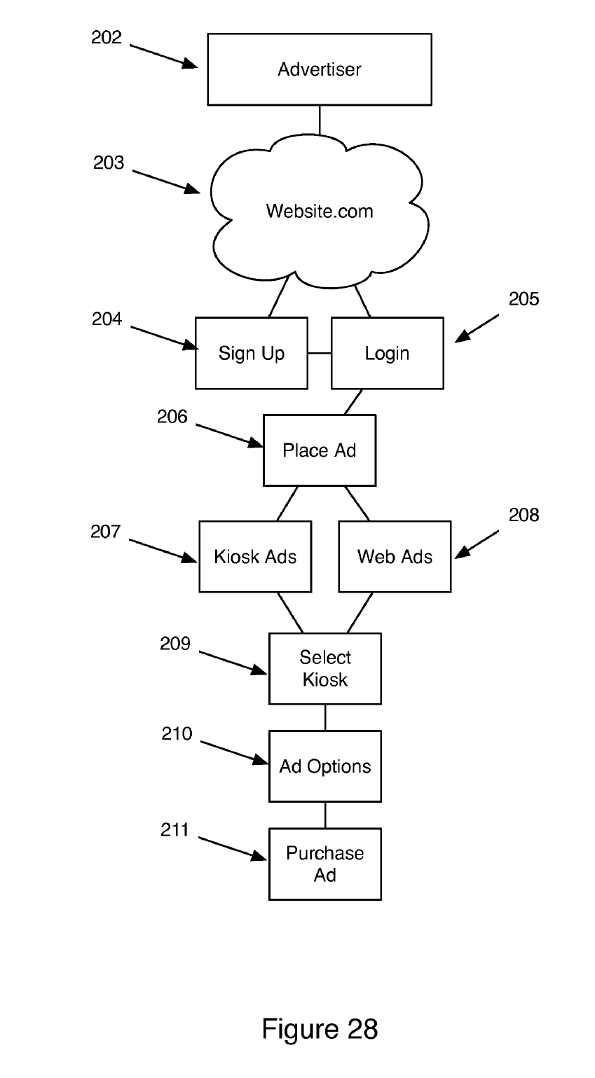

FIG. 28 depicts a novel system of the current invention in which advertisers can place targeted advertisements per-kiosk and per-kiosk webpage. This implementation of an integrated advertising platform does not exist in prior art. An advertiser 202 visits the network's central website 203 and can 204 sign up for an advertising account and then login 205 to place an ad 206. They are then presented with the option to 206 place an ad on the kiosk itself, or on the kiosks associated web page 208. There is no prior art which enables the direct purchase of advertising on a media recording device utilizing a network enabled device. Both options described in 209 enable advertisers to then choose what kiosk(s) and or kiosk(s) associated web page they would like to place an advertisement on. They will be able to select the kiosk based on such criteria as, location, popularity and category within the network. This pinpoint advertising placement is a novel part of the current invention. Prior art does not allow this “cherry picking” of ad placement on specific media recording devices. Upon placing an ad, various advertising options 210 are presented including but not limited to size, position, advertising duration, and type of ad. Once the advertisement options have been selected, the advertiser can purchase the advertisement 211 directly through the web interface.

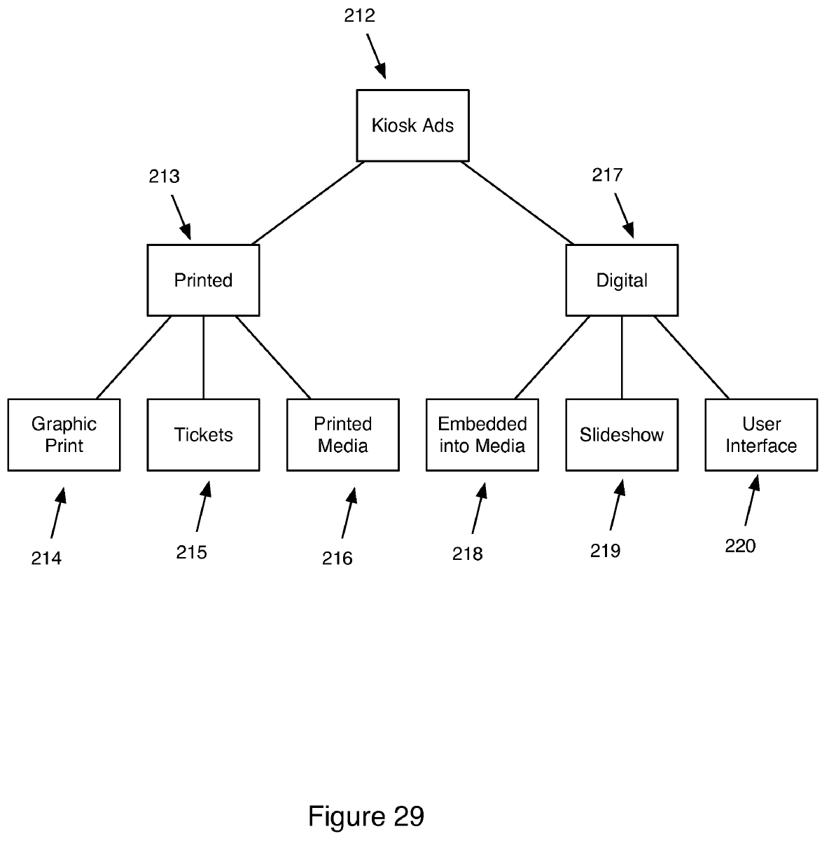

FIG. 29 depicts the placement of advertisements on the apparatus in both printed and digital form. Kiosk advertisements 212 can be printed 213 onto numerous mediums. 214 is the prominently visible graphic print on the casing of the kiosk in which advertisements can be displayed. Promotion tickets 215 which are dispensed and or placed in proximity of a kiosk can have advertisements printed on them as well. Images and or photos which are printed 216 can contain advertisements directly on, or surrounding them. Digital advertisements 217 can be displayed on the apparatus display monitor or monitors. Advertisements can be directly embedded into recorded media 218 ensuring that each time the media is viewed, the advertisement will be seen. Embedding methods include, but are not limited to image watermarking, graphic borders, integrated video and audio. During a media montage or slideshow 219, advertisements can appear intermittently between transistions. The user interface 220 can also have advertisements shown on various screens including but not limited to the idle screen, countdown screen, capture screen, and review screen.

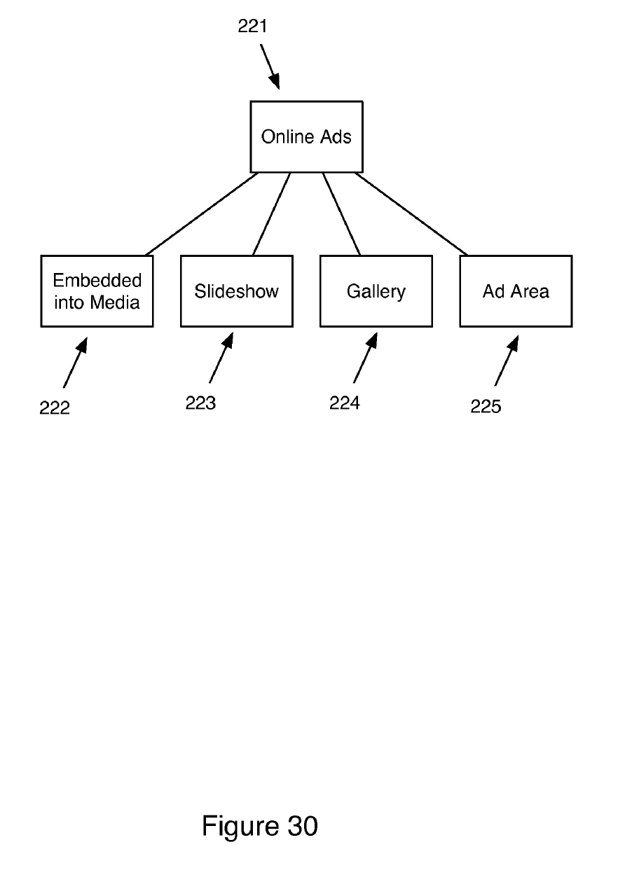

FIG. 30 depicts the placement of 221 advertisements on the network's central website. Advertisements can be directly embedded into media 222 to ensure an advertisement is seen each time the media is viewed. When viewing the online slideshow 223, advertisements may be shuffled into the transitioning media or displayed over or around the currently visible media. If a user is on the website's gallery overview page 224, they are presented with a sequence or grid of media in which advertisements can be placed within the sequence for unobtrusive advertising. The website also contains dedicated 225 advertisement areas or blocks in which advertisements will be visible at all times in various areas.

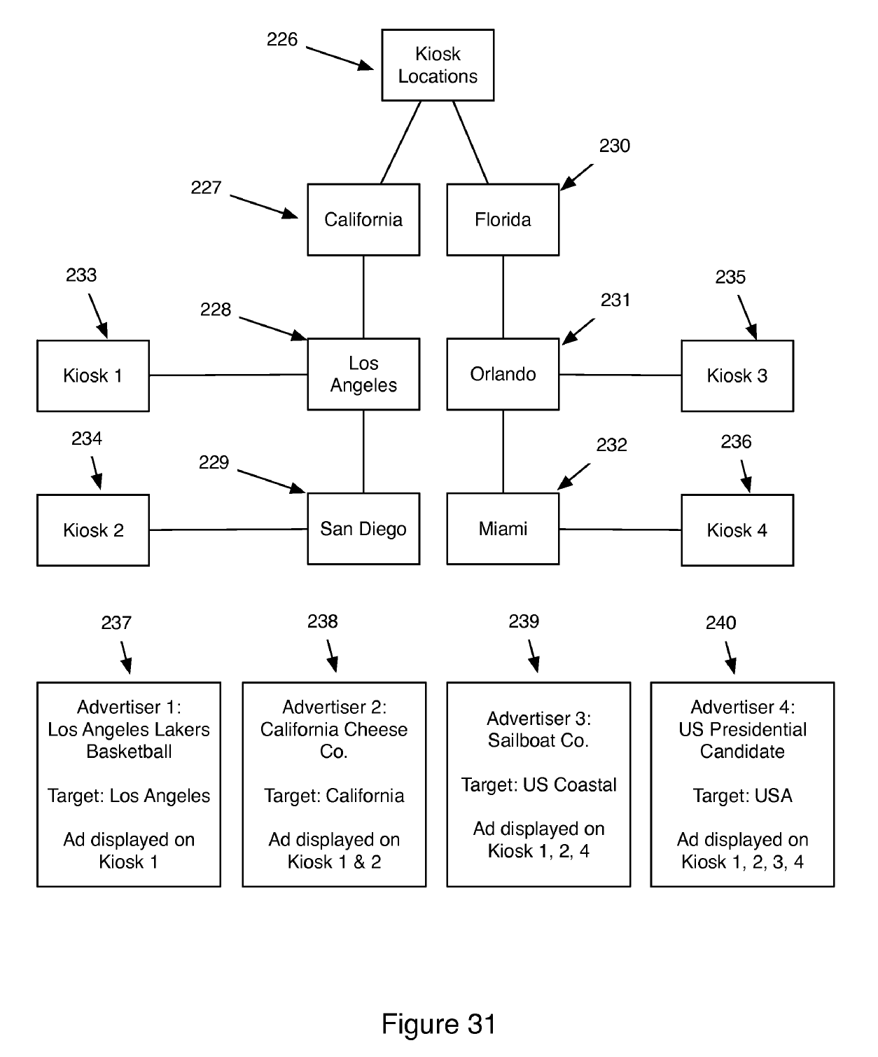

FIG. 31 depicts the benefit advertisers gain in utilizing the current invention's novel ability to strategically and methodically automate the deployment of advertisements within the network based upon geographic location. Kiosk locations 226 consist of geographic data including but not limited to country, state, city, zip code, address, latitude and longitude coordinates. These locations enable advertisers to strategize placement of advertisements based on locale, thus greatly enhancing the ability to reach their target audience. The following scenario is the preferred embodiment of this feature. California 227 has kiosks in both 228 Los Angeles and 229 San Diego. Kiosk 1 233 is located in Los Angeles and Kiosk 2 234 is located in San Diego. 237 depicts how Advertiser 1, who is a Los Angeles Basketball team, wishes to target their advertisements only to kiosks in the Los Angeles region. Therefore only displaying their ad on Kiosk 1. 238 depicts how Advertiser 2, a California Cheese Company wishes to target all of California. Therefore, their ads will be displayed on both Kiosk 1 and Kiosk 2 since they are both located within the parent region of California. Florida 230 has kiosks both in 231 Orlando and 232 Miami. Kiosk 3 235 is located in Orlando which is non-coastal. Kiosk 4 236 is located in the coastal city of Miami 239 depicts how Advertiser 3, a Sailboat Company wishes to broadcast their ads to coastal regions within the US. Since Kiosk 1, Kiosk 2, and Kiosk 4 are all on the coastal line of the United States, Advertiser 3's ad will be displayed on all 3 Kiosks. 240 depicts how Advertiser 3, who is a US Presidential Candidate, wishes to target the entire United States of America. Since all 4 Kiosks in this example are located within the United States, Advertiser 4's ads will be displayed on all kiosks and their associated web pages within the network.

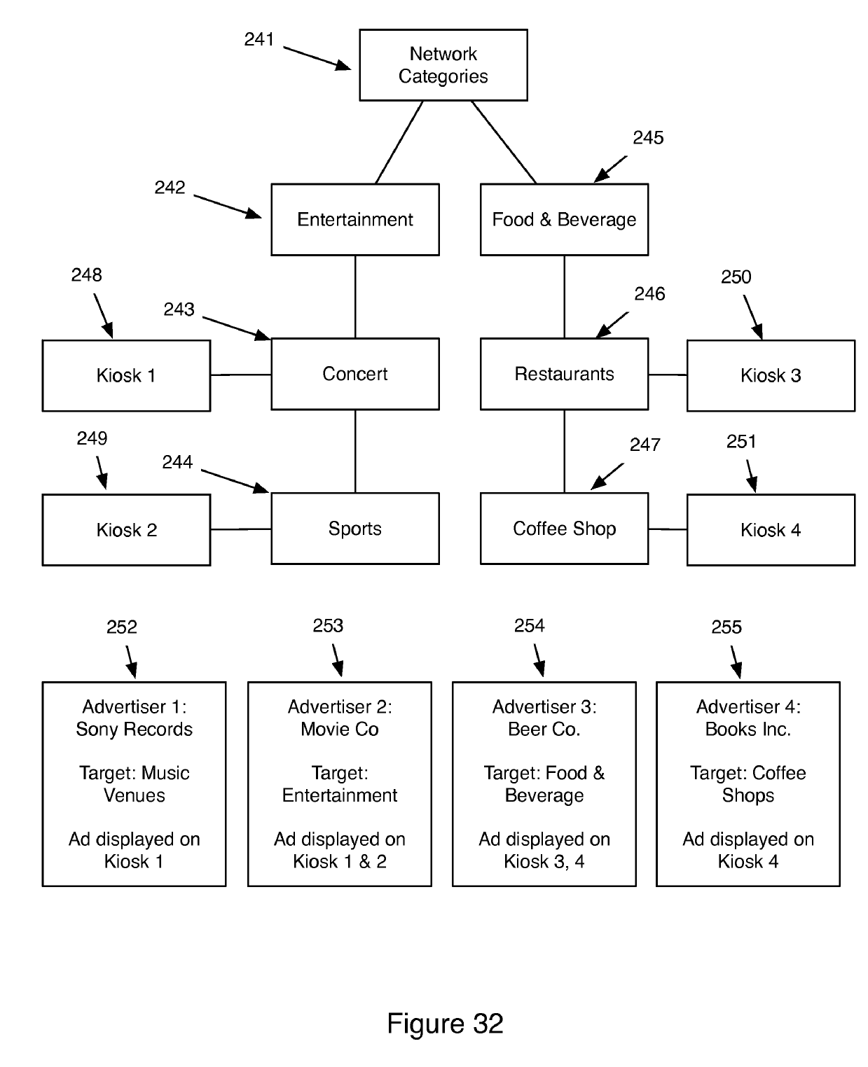

FIG. 32 depicts the benefit advertisers gain in utilizing the current invention's novel ability to strategically and methodically automate the deployment of advertisements within the network based upon categorization. Network categories 241 are set based upon the kiosk's host establishment. One embodiment utilizing the networks categories is explained in the following scenario. Kiosk 1 248 is hosted at a concert venue in which receives the Concert 243 category and thus fall under the parent category of Entertainment 242 as well. Kiosk 249 is located at a sports stadium, it will fall into the network categories of Entertainment 242 and Sports 244. Kiosk 3 250 is hosted in a restaurant which put it in the category of 246 Restaurants and it's parent category 245 Food & Beverage. Kiosk 4 251 is hosted at a Coffee Shop, thus being categorized into 247 Coffee Shop and it's parent category 245 Food & Beverage. These categories are the basis of the system and method's ability to automate the strategic deployment of advertisements. 252 depicts how Advertiser 1, a record label who wishes to target their advertisements to Music Venues, will have their ads automatically deployed on to Kiosk 1 since it is within the Concert category. 253 depicts a Movie Company who wants to reach the entire entertainment network in which their advertisements will be automatically deployed to Kiosk 1 and Kiok2 apparatus and associated web pages. 254 depicts a Beer Company who wishes to target the entire Food & Beverage network, in turn having their ads deployed both on Kiosk 3 and Kiosk 4 apparatus and associated web pages. 255 depicts a Book company who wishes to specifically target kiosks within the Coffee Shop network in which their ads will be only deployed on Kiosk 4 apparatus and associated web page.

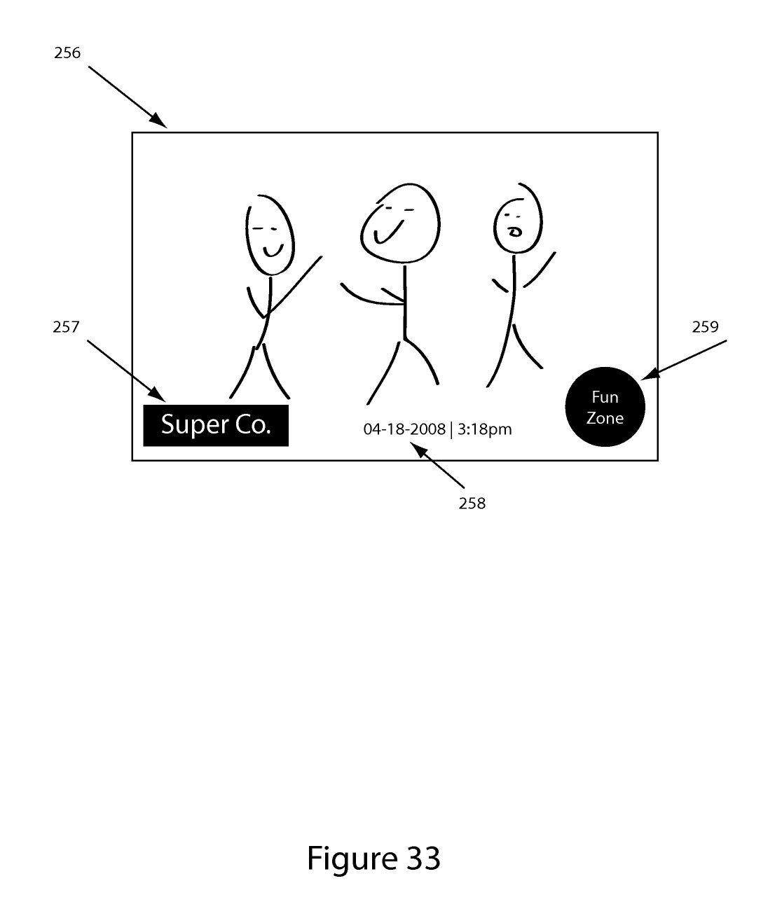

FIG. 33 refers to an example piece of recorded media which shows the preferred embodiment of embedding advertisements and information into media files which are displayed on an apparatus. 256 is a media file which in this case represents a photo or video. 257 is a predefined image supplied by an advertiser whom which has purchased embedded media advertising space. This image is overlayed or watermarked into the actual media file, thus making the advertisement visible each time the media is displayed on an apparatus. 258 is a dynamic time stamp which embeds text representing the date and time said media was recorded. This provides future reference as to exactly when the media was recorded. 259 is another watermark or overlay image which may be an additional advertisement, or a logo supplied by the kiosk administrator to promote their establishment each time the media is displayed on an apparatus.

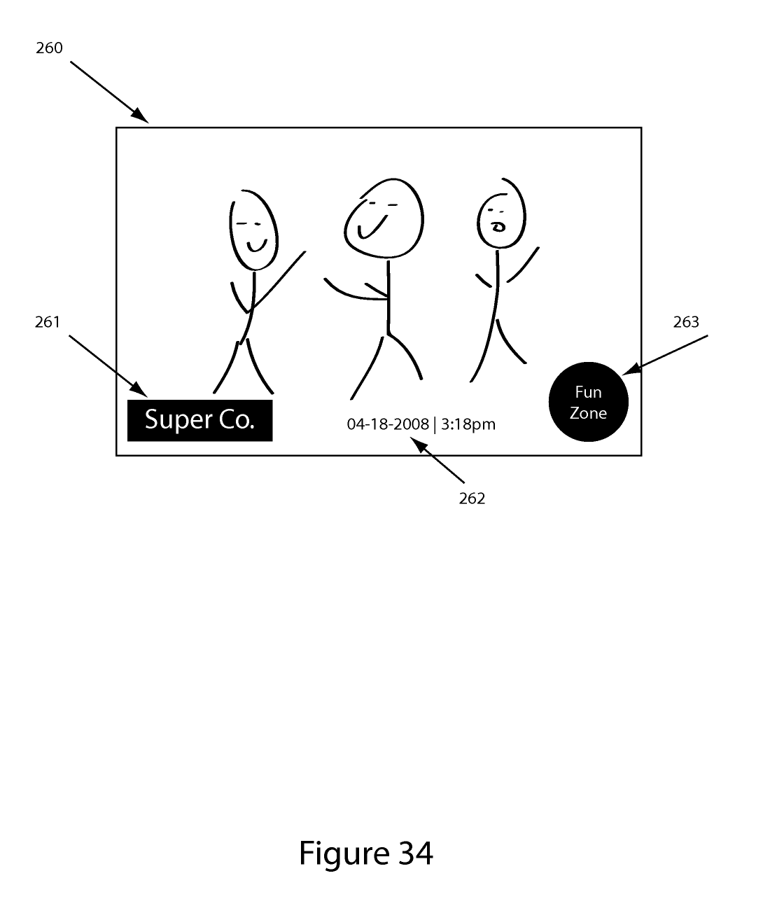

FIG. 34 depicts an image printed from an apparatus and how advertisements and other information may be embedded into the printed recorded media. 260 is a physical print from the apparatus. 261 is a predefined image supplied by an advertiser whom which has purchased embedded media advertising space. This image is overlayed or watermarked into the actual media file, thus making the advertisement visible each time the media is displayed on an apparatus. 262 is a dynamic time stamp which embeds text representing the date and time said media was recorded. This provides future reference as to exactly when the media was recorded. 263 is another watermark or overlay image which may be an additional advertisement, or a logo supplied by the kiosk administrator to promote their establishment each time the media is displayed on an apparatus.

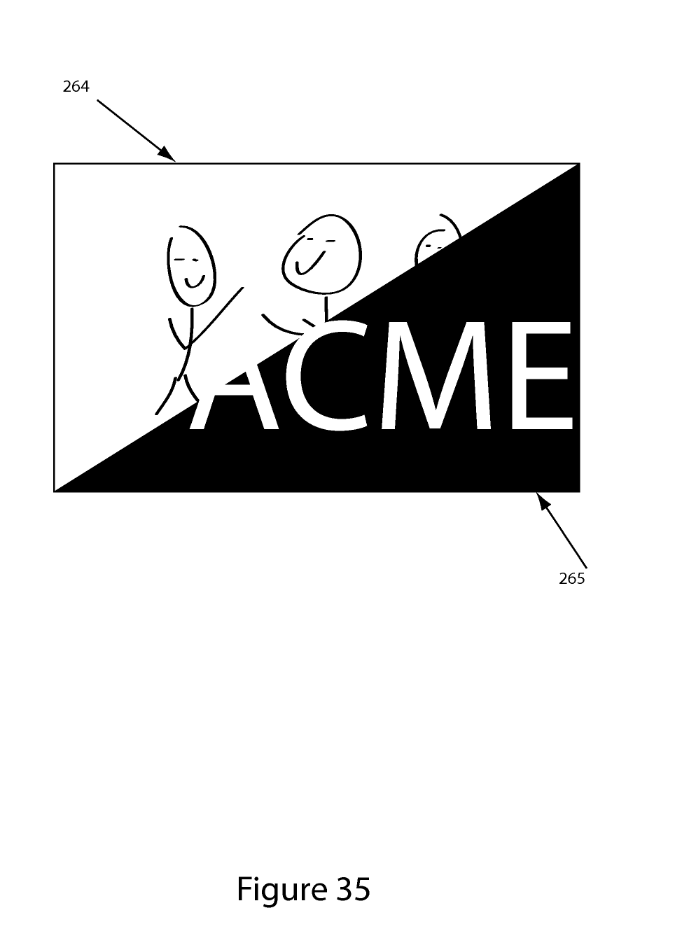

FIG. 35 depicts the media montage or slideshow displayed on the apparatus' screen. During this slideshow, content in the form of images, videos, text, animations and advertisements shuffle between transition effects creating a dynamic collage. You will notice the display is cut in half depicting a sliding, fading, or scrolling transition between 2 pieces of content. 264 is a pre recorded piece of media being transitioned off the screen making room for 265 an advertisement. This represents one of the advertising positions presented to advertisers when purchasing advertising space.

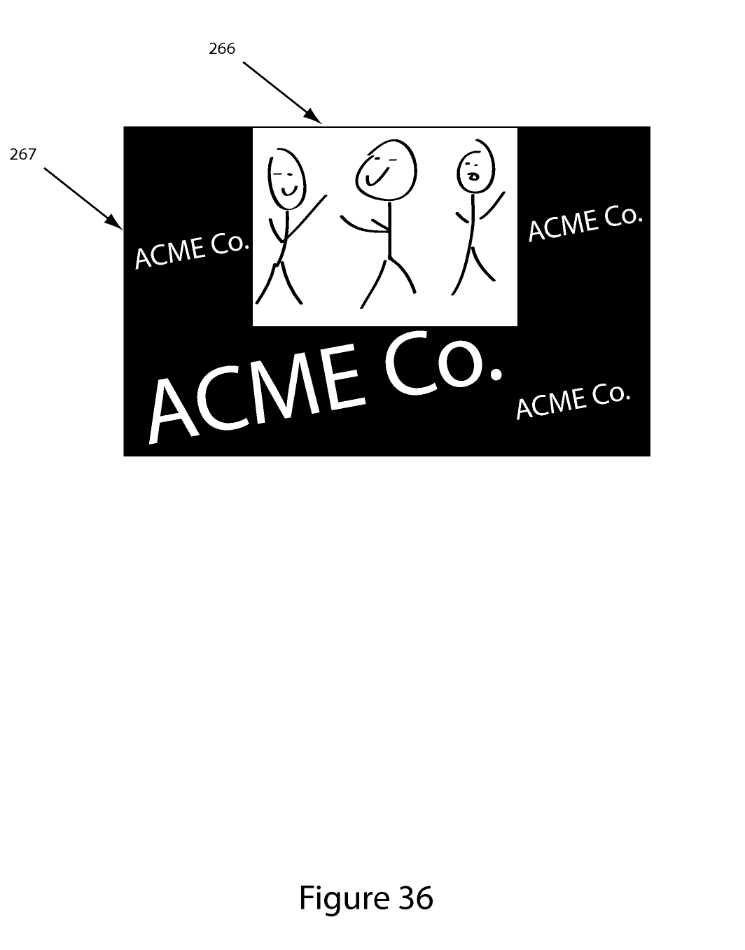

FIG. 36 depicts the screen of the apparatus during the interaction phase. When users are interacting with the machine, they will see 266 content in the form of images, video, or live video stream surrounded by 267 advertising space. This advertising space represents one of the position presented to advertisers when purchasing advertising space.

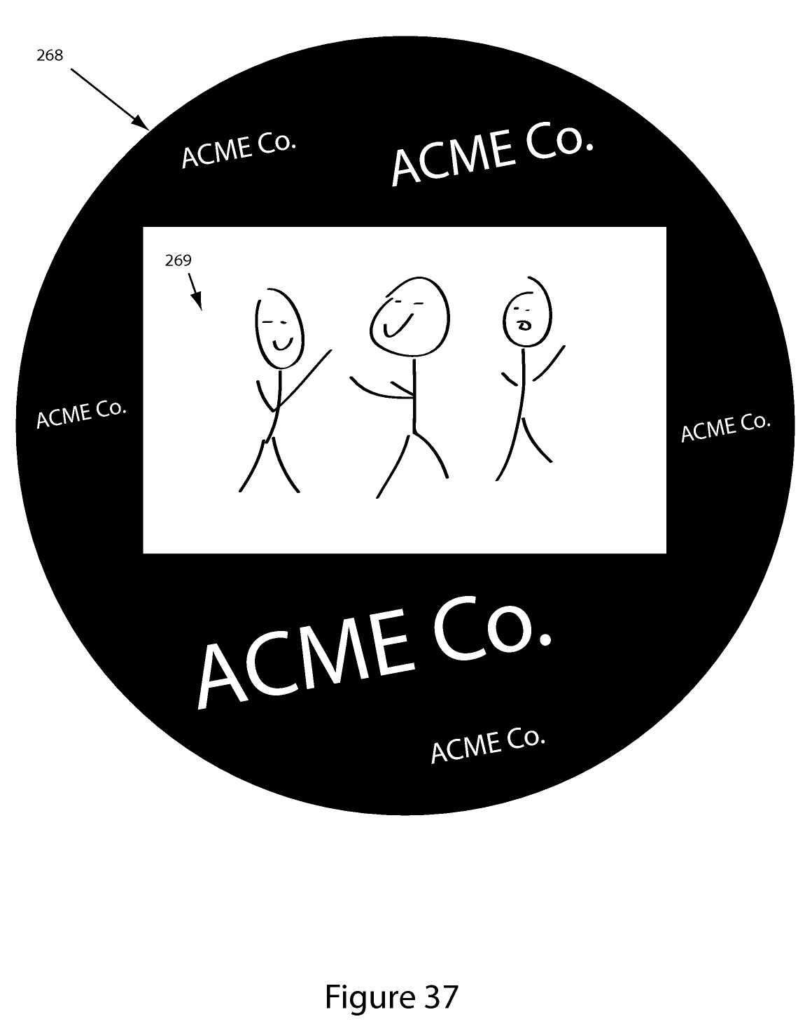

FIG. 37 depicts the front of the apparatus showing it's graphic print advertising area. 268 is a graphic print attached to the apparatus giving advertisers a prominent always visible presence which surrounds the apparatus' 269 display monitor.

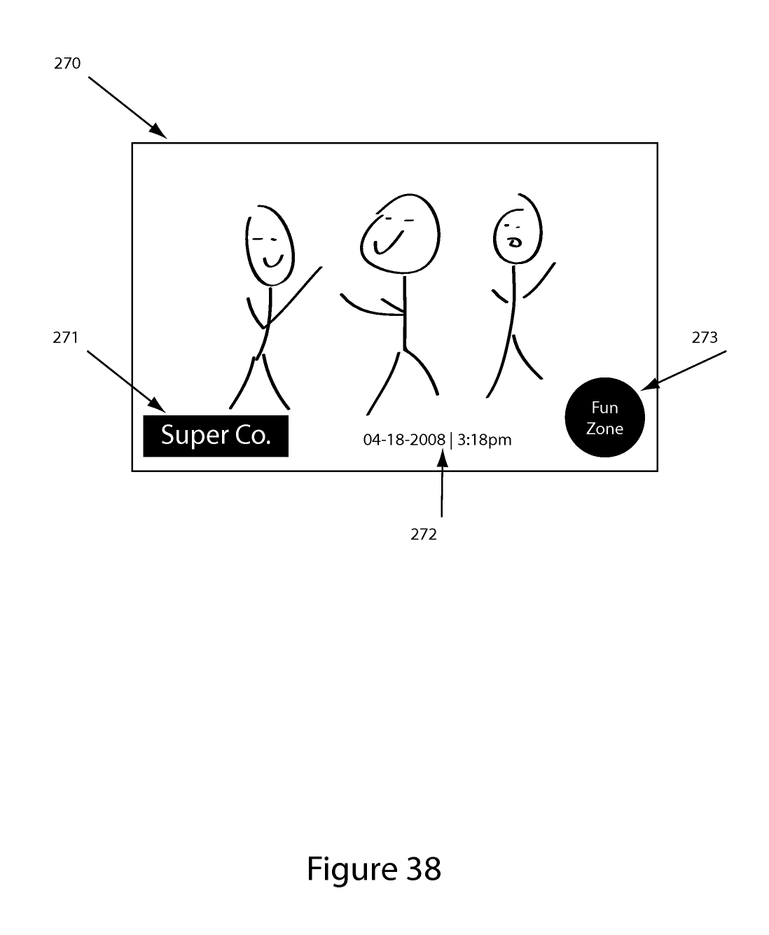

FIG. 38 refers to an example piece of recorded media which shows the preferred embodiment of embedding advertisements and information into media files which are displayed on the website. 270 is a media file which in this case represents a photo or video accessible from the internet. 271 is a predefined image supplied by an advertiser whom which has purchased embedded media advertising space for web content. This image is overlayed or watermarked into the actual media file, thus making the advertisement visible each time the media is displayed on the website. 272 is a dynamic time stamp which embeds text representing the date and time said media was recorded. This provides future reference as to exactly when the media was recorded. 273 is another watermark or overlay image which may be an additional advertisement, or a logo supplied by the kiosk administrator to promote their establishment each time the media is displayed on the website.

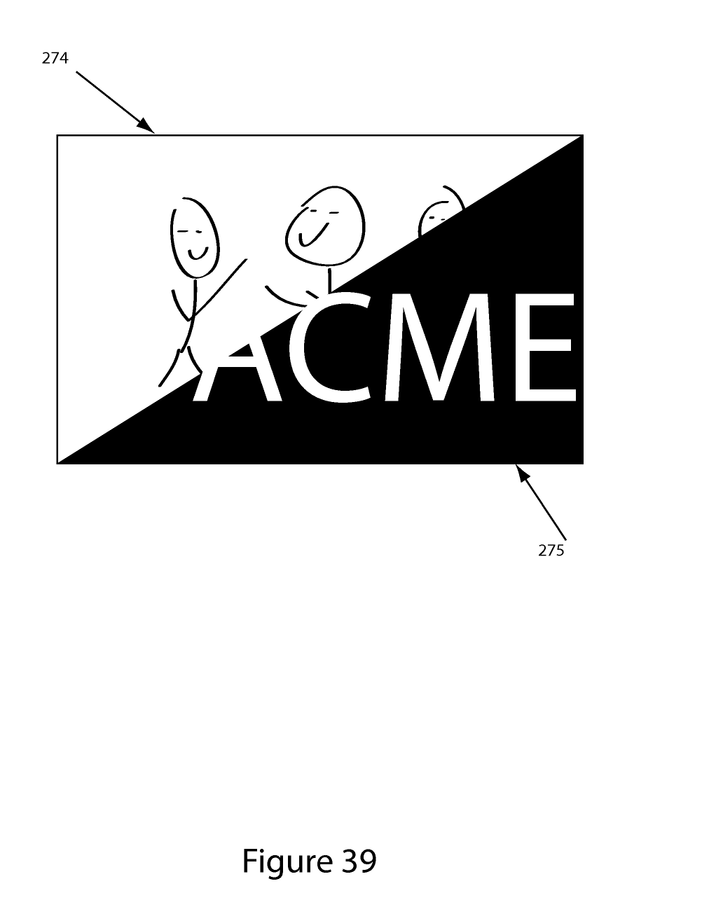

FIG. 39 depicts a media montage or slideshow displayed on the website. During this slideshow, content in the form of images, videos, text, animations and advertisements shuffle between transition effects creating a dynamic collage. You will notice the content area is cut in half depicting a sliding, fading, or scrolling transition between 2 pieces of content. 274 is a pre recorded piece of media being transitioned out of the content area making room for 275 an advertisement. This represents one of the advertising positions presented to advertisers when purchasing advertising space.

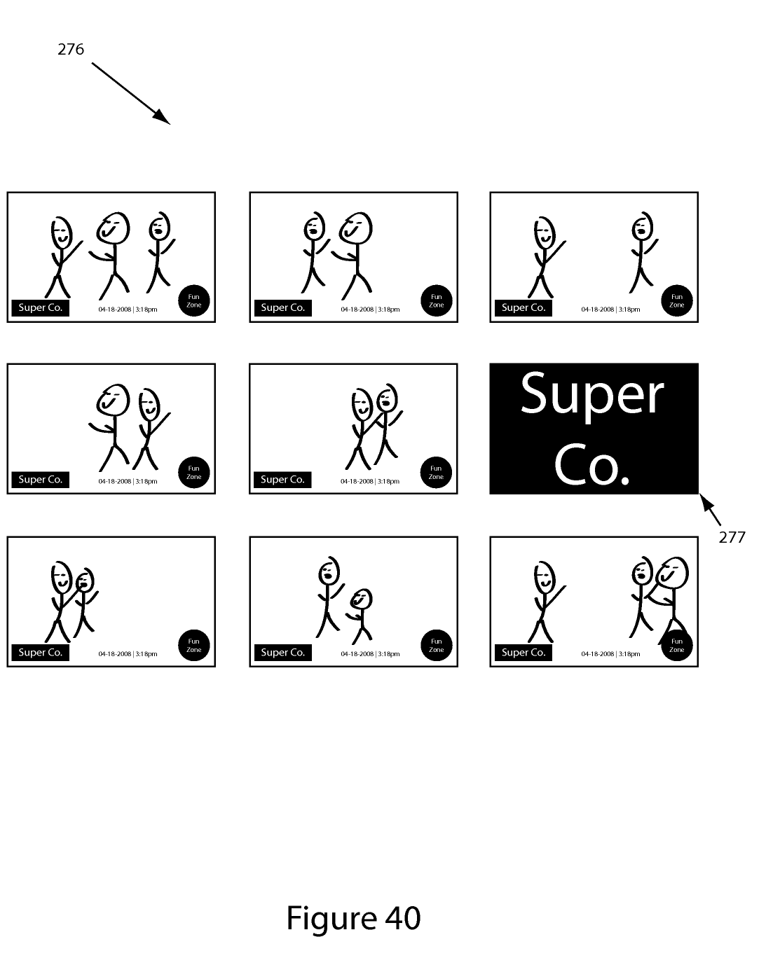

FIG. 40 depicts a view of a gallery on the website. 276 is a grid of recorded media in which a user can browse through to see an overview of the gallery. 277 is an advertisement area which unobtrusively fits right into the gallery. This advertising area is another option presented to advertisers upon purchasing ad space.

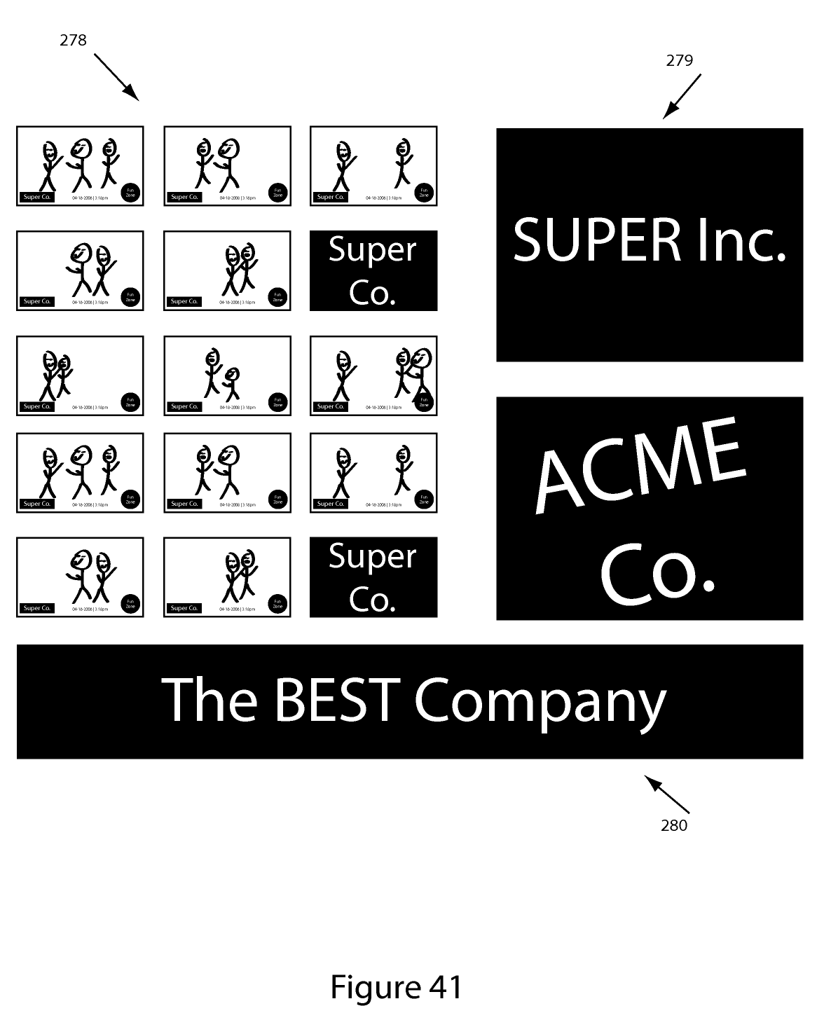

FIG. 41 depicts a view of a gallery on the website which contains additional advertising areas. 278 is the gallery of media grid which is surrounded by 279 and 280 advertising areas. These advertising areas are also options presented to advertisers upon purchasing ad space.

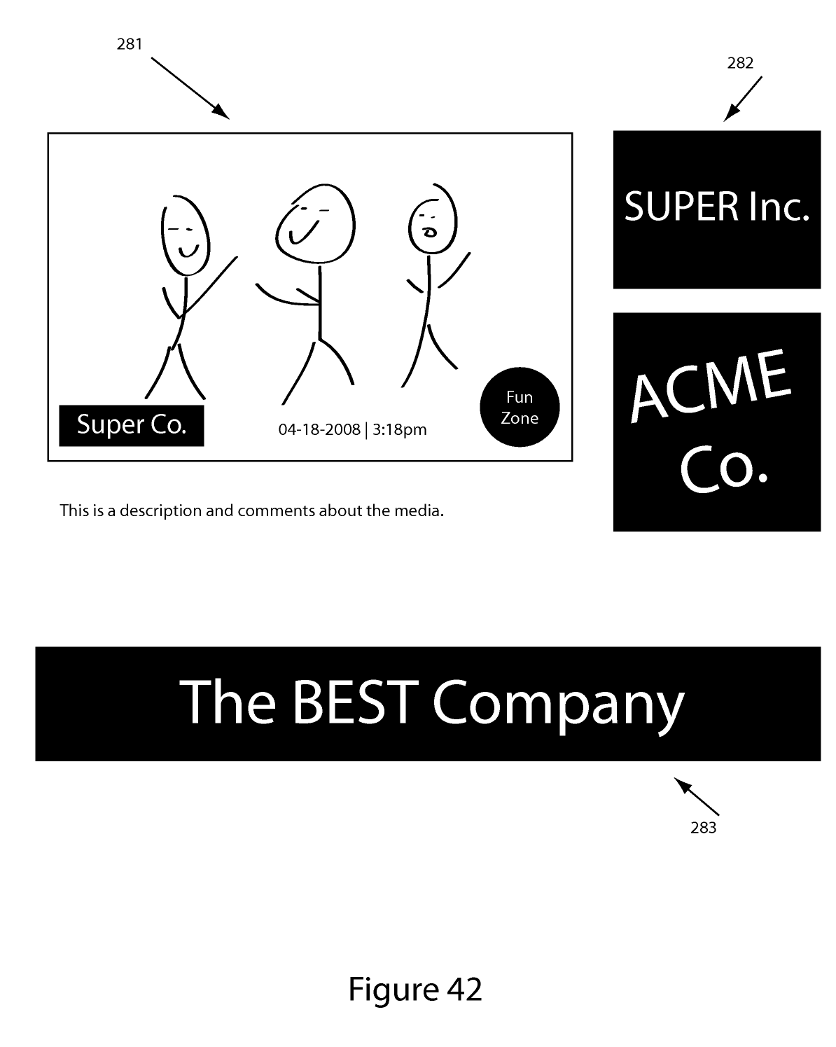

FIG. 42 depicts a view of a single piece of recorded media on the website. This can also be referred to as the detailed view in which a larger version of the recorded media is viewable and where more interaction such as commenting, rating, bookmarking and the like can be done. 281 is the media file which is surrounded by advertising areas 282 and 283.

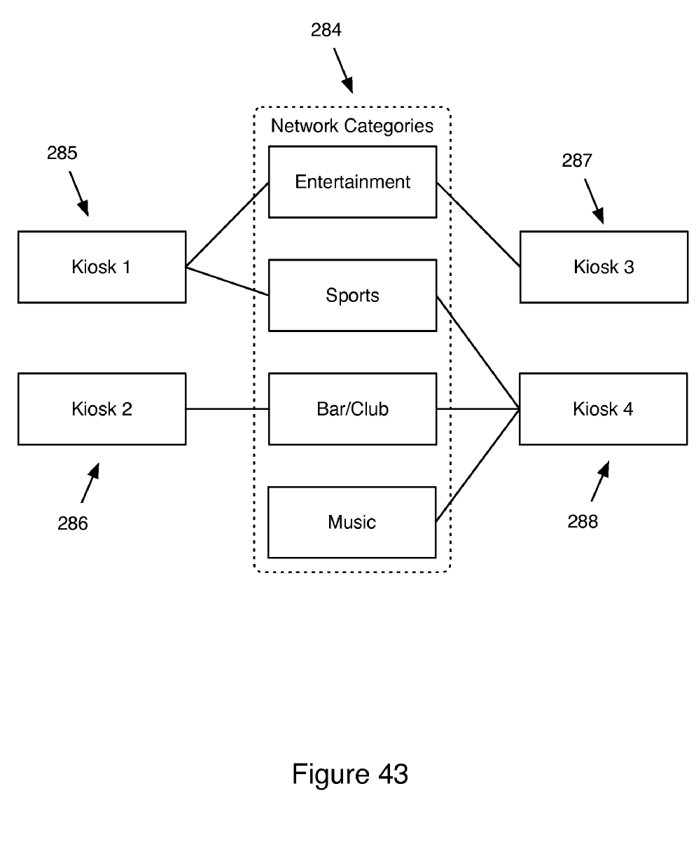

FIG. 43 depicts how categorization makes it possible to link kiosks of similar interest within the network. If desired, content from kiosks which share similar categories can be shared and made visible on the apparatus. The 284 network categories are chosen by a kiosk administrator. Kiosk 1 285 and Kiosk 3 286 share the common category of Entertainment and so media may be shared between both apparatus. Kiosk 1 also shares a category with Kiosk 4. Kiosk 2 287 has the category Bar/Club which is common with Kiosk 4 288 and so they share media between the two apparatus. Kiosk 4 280 also has the category Sports which is shared with Kiosk 1 285 in which content is shared between the two apparatus.

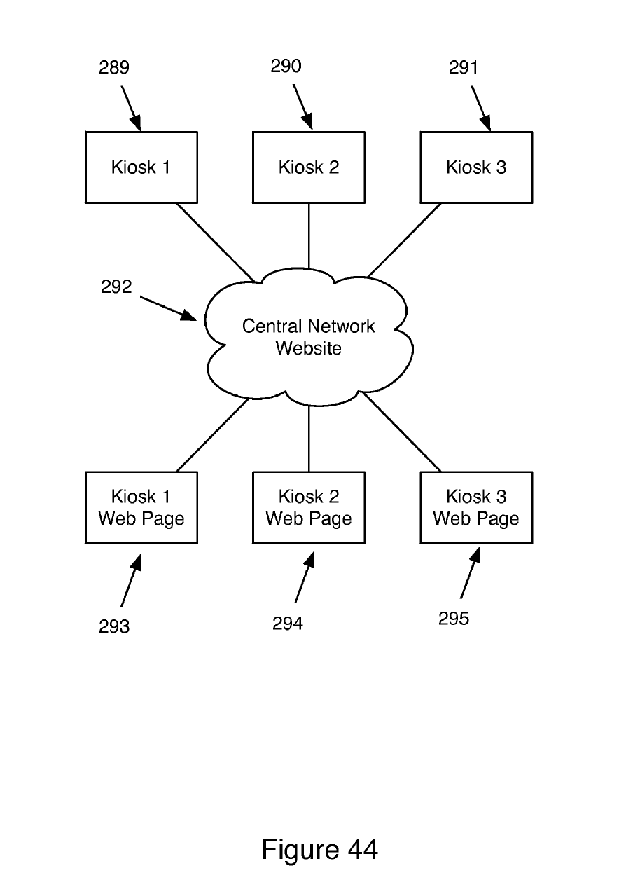

FIG. 44 describes the connection and or association between a Kiosk apparatus and it's dedicated online web page. The network consists of kiosks and web pages and or galleries dedicated for each kiosk. Kiosk 1 289, Kiosk 2 290, and Kiosk 3 291 are all a part of the network and connect to a 292 Central Network Website. Each kiosk has a dedicated web page and or gallery associated with it which is accessible to the public via the Central Network Website. The web page for each kiosk includes a profile, contact information, calendar of events, and other information pertaining to it's associated kiosk host location. Kiosk 1 has a unique Web Page 293, as does Kiosk 2 294, Kiosk 3 295. All content recorded from each kiosk is stored both locally on said kiosk, and remotely, on said central network website within their associated dedicated web section. Content is organized so that each kiosk and it's associated web page is synchronized. You will only see content from Kiosk 1 on Kiosk 1's web page. You will only see content from Kiosk 2 on Kiosk 2's web page. You will only see content from Kiosk 3 on Kiosk 3's web page. Advertisements will be deployed in a similar manner in which they will be displayed in unison between the kiosk apparatus and the associated website.

### ABSTRACT OF THE DISCLOSURE

The current invention is a combination of networked media recording and broadcasting kiosks, an advertising platform, a web based archive of all recorded content, an online community and place to virtually interact with physical locations in real time. This invention overcomes the disadvantages of prior art by connecting the media-recording kiosks to a live interactive network and utilizing it's proprietary advertising platform. Users and advertisers will be able to instantaneously connect with others around the world during and after their interaction with the kiosk. Users will interact with the machine by browsing, viewing and/or listening to content or live streams/chat interaction with other users at a remote kiosk, which can be in the form of literature, images, video and/or audio, live chat, audio or video chat/conferencing. Advertisers will precisely reach their targeted audience by taking advantage of the networks built-in advertising platform. Each kiosk will also communicate with a central network service including but not limited to a website where all content and advertisements will instantaneously be available online for viewing, socializing and interacting, either from the kiosk or other network enabled devices and smart phones or handheld devices. In one embodiment the kiosk may be wall mounted, table top, self-contained stand or suspension mount.

Kiosks will allow users to capture media content which may be automatically uploaded to a network service including, but not limited to a website thus eliminating the need to bring a camera, video recorder or audio recorder. Receiving, formatting and displaying data from other kiosks, and the Internet in the form of images, video, audio and text are a novel part of the current invention. Each kiosk provides real time social networking, advertising opportunities, and remote content moderation, combined with the convenience of having an all-in-one audio and video, image recording device at your disposal.

1.-39. (canceled)

40. An interactive media recording and broadcasting system comprising:
a server configured to transmit media insertion information to a plurality of kiosks based on a characteristic of each kiosk,
wherein one kiosk of the plurality of the kiosks includes:
an input interface configured to receive an input value to activate a function of the one kiosk;
a media recorder configured to record media at the one kiosk;
a media processor configured to:
acquire a characteristic for the one kiosk, and
obtain an inserted version of the recorded media including media insertion information based on the characteristic of the one kiosk and the media recorded at the one kiosk;
a storage device configured to store the inserted media at the one kiosk;
a display configured to present media at the one kiosk; and
a transmitter configured to transmit at least one of the recorded media and the inserted version of the recorded media to the server,
wherein the server is further configured to:
store at least one of: the media recorded at the one kiosk and the inserted version of the recorded media, and
provide the inserted version of the recorded media in response to a request from an electronic device.

41. The interactive media recording and broadcasting system of claim 40, wherein the characteristic of a kiosk includes one or more of: a geographic location of the kiosk, a venue categorization for the location of the kiosk, a current time at the kiosk, a current date at the kiosk, a recording capability of the kiosk, demographics at the kiosk, a number of viewers at the kiosk and a media presentation capability of the kiosk.

42. The interactive media recording and broadcasting system of claim 40, wherein the server is included in the plurality of kiosks.

43. The interactive media recording and broadcasting system of claim 40, wherein the kiosk comprises a wireless communication device.

44. The interactive media recording and broadcasting system of claim 40, wherein the media insertion information comprises digital images, video, audio or text.

45. The interactive media recording and broadcasting system of claim 40, wherein the transmitter is further configured to a transmit the inserted version of the recorded media to another kiosk of the plurality of kiosks, and wherein the kiosk comprises a receiver configured to receive inserted versions of media recorded at the another kiosk from the another kiosk of the plurality of kiosks.

46. The interactive media recording and broadcasting system of claim 45, wherein the transmitting and receiving of inserted versions of media is performed via the server, wherein the server is configured to filter inserted versions of media communicated between the one kiosk and the another kiosk.

47. The interactive media recording and broadcasting system of claim 45, wherein the input interface is configured to receive interaction data for the inserted version of the media received from the another kiosk of the plurality of kiosks, and
wherein the transmitter is configured to transmit the interaction data to at least one of the another kiosk of the plurality of kiosks and the server.

48. The interactive media recording and broadcasting system of claim 47, wherein the interaction data comprises one or more of a comment, a rating, a vote, a categorization, a bookmark, a storage location for the interaction data, location information identifying a location for the interaction data, or a share request.

49. The interactive media recording and broadcasting system of claim 45, wherein the display is configured to present the inserted version of the media received from the another kiosk.

50. The interactive media recording and broadcasting system of claim 40, wherein the display is configured to present the inserted version of the media.

51. The interactive media recording and broadcasting system of claim 40, wherein the recorded media comprises one or more of: a digital image, a video, audio or text.

52. The interactive media recording and broadcasting system of claim 40, wherein the media processor is configured to obtain the inserted version of the recorded media by:
transmitting the recorded media and the characteristic of the one kiosk to the server, and
receiving from the server the inserted version of the recorded media,
wherein the server is configured to:
identify media insertion information based on the characteristic for the one kiosk,
insert the identified media insertion information directly onto the recorded media, and
provide the inserted version of the recorded media to the one kiosk.

53. The interactive media recording and broadcasting system of claim 40, the media processor is configured to obtain the inserted version of the recorded media by:
identifying media insertion information received by the one kiosk based on the characteristic for the one kiosk, and
inserting the identified media insertion information directly onto media recorded by the media recorder at the one kiosk.

54. An interactive media recording and broadcasting method comprising:
receiving media insertion information indicating a digital image, a video, audio or text to add to recorded media, the media insertion information further including a characteristic of the kiosk;
receiving an input value to activate a function of the kiosk;
recording media at a kiosk of a plurality of kiosks;
acquiring a characteristic for the kiosk;
identifying an item of media insertion information received by the kiosk based on the characteristic for the kiosk and the characteristic of the received media insertion information;
inserting the identified item of media insertion information directly onto the recorded media;
presenting the inserted media at the kiosk; and
transmitting the inserted media to a publication server.

55. The interactive media recording and broadcasting method of claim 54, wherein the characteristic of a kiosk includes one or more of: a geographic location of the kiosk, a venue categorization for the location of the kiosk, a current time at the kiosk, a current date at the kiosk, a recording capability of the kiosk, demographics at the kiosk, a number of viewers at the kiosk and a media presentation capability of the kiosk.

56. The interactive media recording and broadcasting method of claim 54, wherein said transmitting and said receiving comprise transmitting and receiving via wireless communication, and wherein the kiosk comprises a wireless communication device.

57. The interactive media recording and broadcasting method of claim 54, wherein the publication server comprises another kiosk of the plurality of kiosks.

58. The interactive media recording and broadcasting method of claim 54, wherein the publication server comprises an Internet website.

59. The interactive media recording and broadcasting method of claim 54, further comprising:
transmitting the inserted media to another kiosk of the plurality of kiosks; and
receiving inserted media recorded at the another kiosk from the another kiosk of the plurality of kiosks.

60. The interactive media recording and broadcasting method of claim 54, further comprising filtering, at the publication server, inserted media communicated between kiosks.

61. The interactive media recording and broadcasting method of claim 59, further comprising:
receiving interaction data for the inserted media received from the another kiosk of the plurality of kiosks; and
transmitting the interaction data to the another kiosk of the plurality of kiosks.

62. The interactive media recording and broadcasting method of claim 59, wherein the interaction data comprises at least one of a comment, a rating, a vote, a categorization, a bookmark, a storage location, location information identifying a location for the interaction data, or a share request.

63. The interactive media recording and broadcasting method of claim 59, further comprising presenting the inserted media received from the another kiosk.

64. The interactive media recording and broadcasting method of claim 54, wherein the recorded media comprises one or more of: a digital image, a video, audio or text.
